(19) United States
(12) Patent Application Publication
(10) Pub. No.: US 2021/0181408 A1
(43) Pub. Date: Jun. 17, 2021

(54) MULTICORE OPTICAL FIBER WITH CHLORINE DOPED CORES

(71) Applicant: CORNING INCORPORATED, Corning, NY (US)

(72) Inventors: Scott Robertson Bickham, Corning, NY (US); Ming-Jun Li, Horseheads, NY (US); Snigdharaj Kumar Mishra, Wilmington, NC (US); Pushkar Tandon, Painted Post, NY (US)

(21) Appl. No.: 17/112,084

(22) Filed: Dec. 4, 2020

Related U.S. Application Data
(60) Provisional application No. 62/946,668, filed on Dec. 11, 2019.

(51) Int. Cl. G02B 6/02; G02B 6/028; G02B 6/036

(52) U.S. Cl. CPC G02B 6/02042; G02B 6/0365; G02B 6/03627; G02B 6/0281

(57) ABSTRACT

A multicore optical fiber includes a first core, a second core, and a common cladding. The first core includes silica and greater than 3 wt % chlorine, a first core centerline, a relative refractive index Δ_{1MAX}, and an outer radius r₁. The second core includes silica and greater than 3 wt % chlorine, a second core centerline, a relative refractive index Δ_{2MAX}, and an outer radius r₂. A spacing between the first core centerline and the second core centerline is at least 28 micrometers and a crosstalk between the first core and the second core is ≤−30 dB, as measured for a 100 km length of the multicore optical fiber operating at a wavelength of 1550 nm.

This application claims the benefit of priority to U.S. Provisional Application Ser. No. 62/946,668 filed on Dec. 11, 2019, the content of which is relied upon and incorporated herein by reference in its entirety.

### FIELD

The present disclosure generally relates to multicore optical fibers, and in particular to multicore optical fibers having chlorine doped cores.

### BACKGROUND

Optical fibers are utilized in a variety of telecommunication applications. Multicore optical fibers can provide increased fiber density compared to single core optical fibers, which can help to address challenges associated with cable size limitations and duct congestion in passive optical network (“PON”) systems. Multicore optical fibers can also be utilized in high speed optical interconnects where there is a need to increase the fiber density to achieve high fiber count connectors. Multicore optical fibers generally include multiple cores embedded in a single common cladding matrix. The performance of multicore optical fibers can be affected by optical loss, i.e., attenuation, of each core as well as crosstalk between cores.

In view of these considerations, there is a need for multicore optical fibers exhibiting low attenuation and low crosstalk.

### SUMMARY

According to an embodiment of the present disclosure, a multicore optical fiber includes a first core, a first inner cladding surrounding the first core, a second core, a second inner cladding surrounding the second core, and a common cladding surrounding the first core and the second core. The first core includes silica and greater than 3 wt % chlorine, wherein the first core comprises a first core centerline, a relative refractive index Δ_{1MAX}, and an outer radius r₁. The first inner cladding includes a relative refractive index Δ_{IC1} and a width δr_{IC1}, wherein Δ_{1MAX}>Δ_{IC1}. The second core includes silica and greater than 3 wt % chlorine, wherein the second core comprises a second core centerline, a relative refractive index Δ_{2MAX}, and an outer radius r₂. The second inner cladding includes a relative refractive index Δ_{IC2} and a width δr_{IC2}, wherein Δ_{2MAX}>Δ_{IC2}. The common cladding includes a relative refractive index Δ_{CC}. A spacing between the first core centerline and the second core centerline is at least 28 micrometers and a crosstalk between the first core and the second core is ≤−30 dB, as measured for a 100 km length of the multicore optical fiber operating at a wavelength of 1550 nm.

According to an embodiment of the present disclosure, a multicore optical fiber includes a first core, a second core, and a common cladding formed from silica-based glass surrounding and in direct contact with the first core and the second core. The first core includes silica and greater than 3 wt % chlorine, wherein the first core comprises a first core centerline, a relative refractive index Δ_{1MAX}, and an outer radius r₁. The second core includes silica and greater than 3 wt % chlorine, wherein the second core comprises a second core centerline, a relative refractive index Δ_{2MAX}, and an outer radius r₂. The common cladding has a relative refractive index Δ_{CC}. A spacing between the first core centerline and the second core centerline is at least 28 micrometers and a crosstalk between the first core and the second core is ≤−30 dB, as measured for a 100 km length of the multicore optical fiber operating at a wavelength of 1550 nm.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a schematic of a multicore optical fiber, according to aspects of the present disclosure;

FIG. 2 is a cross-sectional view of the multicore optical fiber of FIG. 1 taken along the line II-II, according to aspects of the present disclosure;

FIG. 3 is a cross-sectional schematic of a ribbon-type multicore optical fiber, according to aspects of the present disclosure;

FIG. 4A is a cross-sectional schematic of an exemplary core and inner cladding of a multicore optical fiber, according to aspects of the present disclosure;

FIG. 4B is a cross-sectional schematic of an exemplary core, inner cladding, and outer cladding of a multicore optical fiber, according to aspects of the present disclosure;

FIG. 5 is a refractive index profile for a multicore optical fiber having a chlorine doped core and an undoped silica common cladding, according to aspects of the present disclosure;

FIG. 6 is a refractive index profile for a multicore optical fiber having a chlorine doped core and chlorine doped common cladding, according to aspects of the present disclosure;

FIG. 7 is a refractive index profile for a multicore optical fiber having a chlorine doped core and chlorine doped common cladding, according to aspects of the present disclosure;

FIG. 8 is a refractive index profile for a multicore optical fiber having a chlorine doped core, a fluorine doped inner cladding, and an undoped silica common cladding, according to aspects of the present disclosure;

FIG. 9 is a refractive index profile for a multicore optical fiber having a chlorine doped core, a fluorine doped inner cladding, and a fluorine doped common cladding, according to aspects of the present disclosure;

FIG. 10 is a refractive index profile for a multicore optical fiber having a chlorine doped core, a fluorine doped inner cladding, and a chlorine doped common cladding, according to aspects of the present disclosure;

FIG. 11 is a plot illustrating crosstalk between adjacent cores as a function of core centerline to core centerline spacing, according to aspects of the present disclosure;

FIG. 12 is a refractive index profile for a multicore optical fiber having a chlorine doped core, a fluorine doped inner cladding, and an undoped silica common cladding, according to aspects of the present disclosure;

FIG. 13 is a refractive index profile for a multicore optical fiber having a chlorine doped core, a fluorine doped inner cladding, and a chlorine doped common cladding, according to aspects of the present disclosure;

FIG. 14 is a refractive index profile for a multicore optical fiber having a chlorine doped core, an undoped silica inner cladding, and a chlorine doped common cladding, according to aspects of the present disclosure; and

FIG. 15 is a refractive index profile for a multicore optical fiber having a chlorine doped core, an undoped silica inner cladding, a fluorine doped outer cladding, and an undoped silica common cladding, according to aspects of the present disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

A multicore optical fiber, also referred to as a multicore fiber or “MCF”, is considered for the purposes of the present disclosure to include two or more core fibers disposed within a cladding matrix. Each core fiber can be considered as having a core surrounded by a cladding matrix defining an common cladding. Optionally, each core fiber can include a core surrounded by one or more inner claddings disposed between each core and the cladding matrix of the common cladding. “Radial position,” “radial distance,” when used in reference to the radial coordinate “r” refers to radial position relative to the centerline (r=0) of each individual core in a multicore optical fiber. “Radial position,” “radial distance,” when used in reference to the radial coordinate “R” refers to radial position relative to the centerline (R=0, central fiber axis) of the multicore optical fiber. The length dimension “micrometer” may be referred to herein as micron (or microns) or μm.

The “refractive index profile” is the relationship between refractive index or relative refractive index and radial distance r from the core's centerline for each core fiber of the multicore optical fiber. For relative refractive index profiles depicted herein as having step boundaries between adjacent core and cladding regions, normal variations in processing conditions may result in step boundaries at the interface of adjacent regions that are not sharp. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (core region and/or any of the cladding regions), it may be expressed in terms of its actual or approximate functional dependence or in terms of an average value applicable to the region. Unless otherwise specified, if the relative refractive index of a region (core region and/or any of the inner and/or common cladding regions) is expressed as a single value, it is understood that the relative refractive index in the region is constant, or approximately constant, and corresponds to the single value or that the single value represents an average value of a non-constant relative refractive index dependence with radial position in the region. Whether by design or a consequence of normal manufacturing variability, the dependence of relative refractive index on radial position may be sloped, curved, or otherwise non-constant.

The “relative refractive index” or “relative refractive index percent” as used herein with respect to multicore optical fibers and fiber cores of multicore optical fibers is defined according to equation (1):

$$Δ \% = 100 \frac{{n}^{2} ( r ) - {n}_{c}^{2}}{2 {n}^{2} ( r )} \qquad ( 1 )$$

where n(r) is the refractive index at the radial distance r from the core's centerline at a wavelength of 1550 nm, unless otherwise specified, and n_{c} is 1.444, which is the refractive index of undoped silica glass at a wavelength of 1550 nm. As used herein, the relative refractive index is represented by Δ (or “delta”) or Δ % (or “delta %) and its values are given in units of “%” or “% A”, unless otherwise specified. Relative refractive index may also be expressed as Δ(r) or Δ(r) %. When the refractive index of a region is less than the reference index n_{c}, the relative refractive index is negative and can be referred to as a trench. When the refractive index of a region is greater than the reference index n_{c}, the relative refractive index is positive and the region can be said to be raised or to have a positive index.

The average relative refractive index of a region of the multicore optical fiber can be defined according to equation (2):

$$Δ \% = \frac{{\int }_{{r}_{inner}}^{{r}_{outer}} Δ ( r ) dr}{( {r}_{o u t e r} - {r}_{i n n e r} )} \qquad ( 2 )$$

where rᵢₙₙₑᵣ is the inner radius of the region, rₒᵤₜₑᵣ is the outer radius of the region, and Δ(r) is the relative refractive index of the region.

The term “α-profile” (also referred to as an “alpha profile”) refers to a relative refractive index profile Δ(r) that has the following functional form (3):

$$Δ ( r ) = {Δ ( {r}_{0} ) [ 1 - \frac{\vert r - {r}_{0} \vert}{( {r}_{1} - {r}_{0} )} ]}^{α} \qquad ( 3 )$$

where r₀ is the point at which Δ(r) is maximum, r₁ is the point at which Δ(r) is zero, and r is in the range rᵢ≤r≤r_{f}, where rᵢ is the initial point of the α-profile, r_{f} is the final point of the α-profile, and α is a real number. In some embodiments, examples shown herein can have a core alpha of 1≤α≤100. In practice, an actual optical fiber, even when the target profile is an alpha profile, some level of deviation from the ideal configuration can occur. Therefore, the alpha parameter for an optical fiber may be obtained from a best fit of the measured index profile, as is known in the art.

The term “graded-index profile” refers to an α-profile, where α<10. The term “step-index profile” refers to α-profile, where α≥10.

The “effective area” can be defined as (4):

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 4 )$$

where f(r) is the transverse component of the electric field of the guided optical signal and r is radial position in the fiber. “Effective area” or “A_{eff}” depends on the wavelength of the optical signal. Specific indication of the wavelength will be made when referring to “Effective area” or “A_{eff}” herein. Effective area is expressed herein in units of “μm²”, “square micrometers”, “square microns” or the like.

The “mode field diameter” or “MFD” of an optical fiber is defined as MFD=2w, where w is defined as (5):

$${w}^{2} = \frac{{\int }_{0}^{∞} {( f ( r ) )}^{2} rdr}{{\int }_{0}^{∞} {( \frac{df ( r )}{dr} )}^{4} rdr} \qquad ( 5 )$$

where fir) is the transverse component of the electric field distribution of the guided optical signal and r is radial position in the fiber. “Mode field diameter” or “MFD” depends on the wavelength of the optical signal. Specific indication of the wavelength will be made when referring to “mode field diameter” or “MFD” herein.

As used herein, “trench volume” is the volume of the outer cladding surrounding core i and is defined as (61:

$${V}_{trench} = {V}_{ICi} = \vert 2 {\int }_{{r}_{i}}^{{r}_{i} + δ {r}_{ICi}} ( {Δ}_{ICi} ( r ) - {Δ}_{C C} ) rdr \vert \qquad ( 6 )$$

where rᵢ is the inner radius of the trench region surrounding core i, rᵢ+δr_{ICi}, is the outer radius of the trench region surrounding core i, Δ_{ICi}(r) is the relative refractive index of the trench region, Δ_{CC} is the relative refractive index of the common cladding surrounding the trench region, and r is radial position in the fiber core. Trench volume is an absolute value and a positive quantity and will be expressed herein in units of % Δ-square micrometers, % Δmicron², % Δ-micron², % Δ-μm², or % Δμm², whereby these units can be used interchangeably herein. As used herein, when present, an inner cladding surrounding a core forms a trench, and thus for the purposes of the present disclosure, the terms inner cladding and trench can be used interchangeably to refer to the same region of the multicore optical fiber.

“Chromatic dispersion”, herein referred to as “dispersion” unless otherwise noted, of an optical fiber is the sum of the material dispersion, the waveguide dispersion, and the intermodal dispersion. In the case of single mode waveguide fibers, the inter-modal dispersion is zero. Dispersion values in a two-mode regime assume intermodal dispersion is zero. The zero dispersion wavelength (4) is the wavelength at which the dispersion has a value of zero. Dispersion slope is the rate of change of dispersion with respect to wavelength. Dispersion and dispersion slope are reported herein at a wavelength of 1310 nm or 1550 nm, as noted, and are expressed in units of ps/nm/km and ps/nm²/km, respectively

The cutoff wavelength of an optical fiber is the minimum wavelength at which the optical fiber will support only one propagating mode. For wavelengths below the cutoff wavelength, multimode transmission may occur and an additional source of dispersion may arise to limit the fiber's information carrying capacity. Cutoff wavelength will be reported herein as a cable cutoff wavelength. The cable cutoff wavelength is based on a 22-meter cabled fiber length as specified in TIA-455-80: FOTP-80 IEC-60793-1-44 Optical Fibres Part 1-44: Measurement Methods and Test Procedures Cut-off Wavelength (21 May 2003), by Telecommunications Industry Association (TIA).

The “theoretical cutoff wavelength”, or “theoretical fiber cutoff”, or “theoretical cutoff”, for a given higher-order mode, is the wavelength above which guided light cannot propagate in that higher-order mode. According to an aspect of the present disclosure, the cutoff wavelength refers to the cutoff wavelength of the LP11 mode. A mathematical definition can be found in Single Mode Fiber Optics, Jeunhomme, pp. 39-44, Marcel Dekker, New York, 1990, wherein the theoretical fiber cutoff is described as the wavelength at which the mode propagation constant becomes equal to the plane wave propagation constant in the common cladding. This theoretical wavelength is appropriate for an infinitely long, perfectly straight fiber that has no diameter variations.

The bend resistance of an optical fiber may be gauged by bend-induced attenuation under prescribed test conditions. In the present description, bend losses were determined by a mandrel wrap test. In the mandrel wrap test, the fiber is wrapped around a mandrel having a specified diameter and the attenuation of the fiber in the wrapped configuration at 1550 nm is determined. The bend loss is reported as the increase in attenuation of the fiber in the wrapped configuration relative to the attenuation of the fiber in an unwrapped (straight) configuration. Bend loss is reported herein in units of dB/turn, where one turn corresponds to a single winding of the fiber about the circumference of the mandrel. Bend losses for mandrel diameters of 10 mm, 15 mm, 20 mm, 30 mm, 40 mm, 50 mm, and 60 mm were determined.

As used herein, the multicore optical fiber can include a plurality of cores, wherein each core can be defined as an i^{th} core (i.e., 1^{st}, 2^{nd}, 3^{rd}, 4^{th}, etc. . . . ). Each i^{th} core can have an outer radius rᵢ and a relative refractive index Δ_{iMAX}. Each i^{th} core is disposed within a cladding matrix of the multicore optical fiber which defines a common cladding of the multicore optical fiber. The common cladding includes a relative refractive index Δ_{CC} and an outer radius R_{CC}. Optionally, each i^{th} core is surrounded by a corresponding i^{th} inner cladding having a width δr_{ICi} and a relative refractive index Δ_{ICi}. Optionally, each i^{th} core can be surrounded by a corresponding i^{th} inner cladding having a width δr_{ICi} and a relative refractive index Δ_{ICi}, which is surrounded by a corresponding i^{th} outer cladding having a width δroc, and a relative refractive index Δ_{OCi}. Thus, i=1 refers to a first core having an outer radius r₁ and relative refractive index Δ₁ and a maximum relative refractive index Δ_{1MAX}. When the first core is surrounded by a corresponding it^{h} inner cladding, where i=1, it is referred to as the first inner cladding and has a width δr_{IC1} and a relative refractive index Δ_{IC1}. When the first inner cladding is surrounded by a corresponding i^{th} outer cladding, it is referred to as the first outer cladding and has a width δr_{OC1} and a relative refractive index Δ_{OC1}. When i=2, the core is referred to as a second core having an outer radius r₂ and relative refractive index Δ_{2MAX}. When the second core is surrounded by a corresponding i^{th} inner cladding, where i=2, it is referred to as the second inner cladding and includes a width δr_{IC2} and a relative refractive index Δ_{IC2}. Each additional i^{th} core and optional i^{th} inner cladding and optional i^{th} outer cladding is referred to as a third core and optional third inner cladding and optional third outer cladding (i=3), a fourth core and optional fourth inner cladding and optional fourth outer cladding (i=4), etc. . . . . The number assigned to each i^{th} core is used to distinguish one core from another for the purposes of discussion and does not necessarily imply any particular ordering of the cores.

According to one aspect of the present disclosure, the core forms the central portion of each core fiber within the multicore optical fiber and is substantially cylindrical in shape. In addition, when present, the surrounding inner cladding region is substantially annular in shape. Annular regions may be characterized in terms of an inner radius and an outer radius. Radial positions r refer herein to the outermost radii of the region (e.g., the core, the inner cladding region, etc. . . . ). When two regions are directly adjacent to each other, the outer radius of the inner of the two regions coincides with the inner radius of the outer of the two regions. For example, in embodiments in which an inner cladding region surrounds and is directly adjacent to a core region, the outer radius of the core region coincides with the inner radius of the inner cladding region and the outer radius of the inner cladding region is separated from the inner radius of the inner cladding region by the width δr_{IC}.

The present illustrated embodiments generally relate to multicore optical fibers having at least two core fibers, wherein each core fiber includes a core comprising silica and greater than 3% chlorine, by weight (wt %), and a crosstalk between adjacent cores of ≤−30 dB, as measured for a 100 km length of the multicore optical fiber operating at a wavelength of 1550 nm. Accordingly, elements of the present disclosure have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Aspects of the present disclosure generally relate to a multicore optical fiber in which each core includes silica glass and greater than 3 wt % chlorine. The relative refractive index profile of each core, optional inner cladding, and an common cladding can be tailored in combination with the spacing between adjacent cores to provide a multicore optical fiber having a crosstalk between the first core and the second core is ≤−30 dB, as measured for a 100 km length of the multicore optical fiber operating at a wavelength of 1550 nm. In some examples, the relative refractive index profile of each core, optional inner cladding, and the common cladding can be tailored in combination with the spacing between adjacent cores to provide a multicore optical fiber having different mode field diameters and/or attenuation. The multicore optical fibers of the present disclosure can provide higher core density in a single fiber than a conventional fiber including a single core.

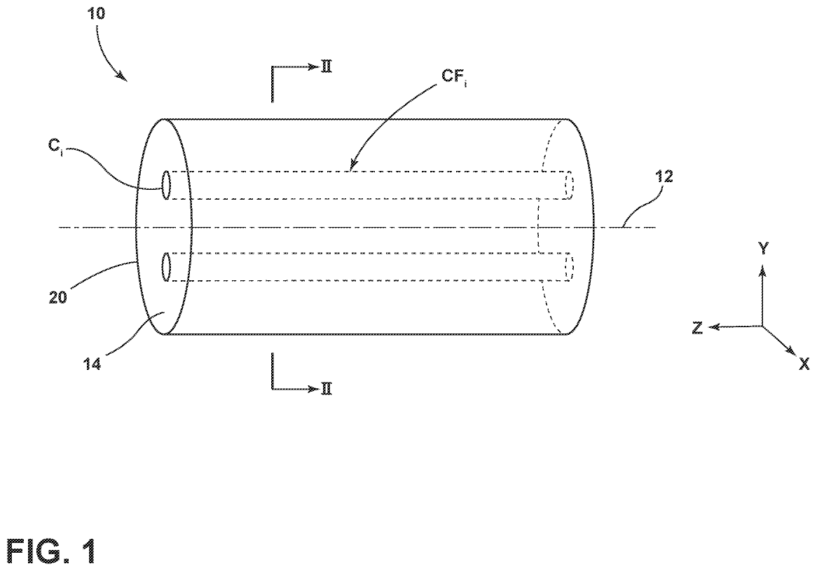

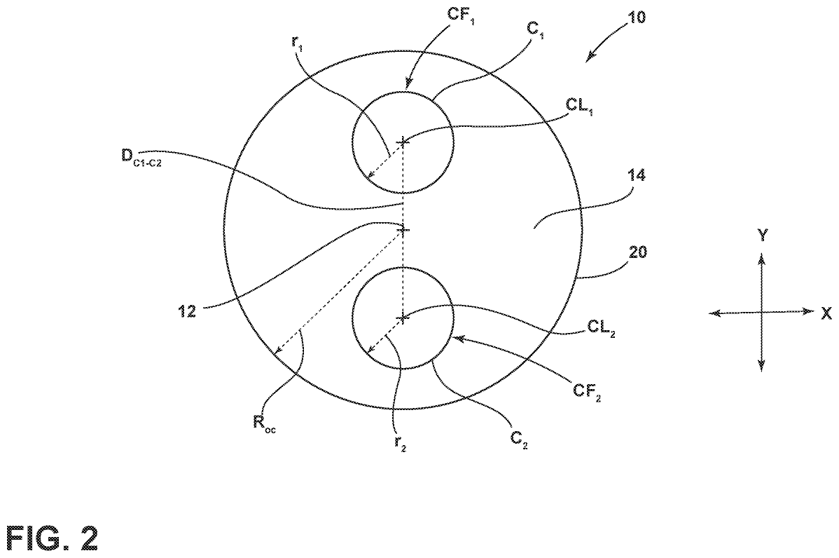

FIGS. 1 and 2 illustrate an isometric view of a section of a multicore optical fiber 10 and a cross-sectional view of the multicore optical fiber 10, respectively. The multicore optical fiber 10 includes a central fiber axis 12 (the centerline of the multicore optical fiber 10) and a cladding matrix 14 defining a common cladding 20. The common cladding 20 can have an outer radius R_{CC}, which in the illustrated embodiment of FIGS. 1 and 2 corresponds to the outer radius of the multicore optical fiber 10. A plurality of cores Cᵢ (individually denoted C₁ and C₂ in the example of FIGS. 1 and 2 and collectively referred to as cores “C”) are disposed within the cladding matrix 14, with each core Cᵢ forming a core fiber CFᵢ that generally extends through a length of the multicore optical fiber 10 parallel to the central fiber axis 12. With reference to FIG. 2, each core C₁ and C₂ includes a central axis or centerline CL₁ and CL₂ and an outer radius r₁ and r₂, respectively. A position of each of the centerlines CL₁ and CL₂ within the multicore optical fiber 10 can be defined using Cartesian coordinates with the central fiber axis 12 defining the origin (0, 0) of an x-y coordinate system coincident with the coordinate system defined by the radial coordinate R. The position of centerline CL₁ can be defined as (x₁, y₁) and the position of centerline CL₂ can be defined as (x₂, y₂). A distance D_{C1-C2} between the centerlines CL₁ and CL₂ can then be defined as √[(x₂−x₁)²+(y₂−y₁)²]. Thus, for a given core Cᵢ having a centerline CLᵢ and an adjacent core Cⱼ having a centerline CLⱼ, a distance D_{Ci-Cj} is defined as √[(xⱼ−xᵢ)²+(yⱼ−yᵢ)²].

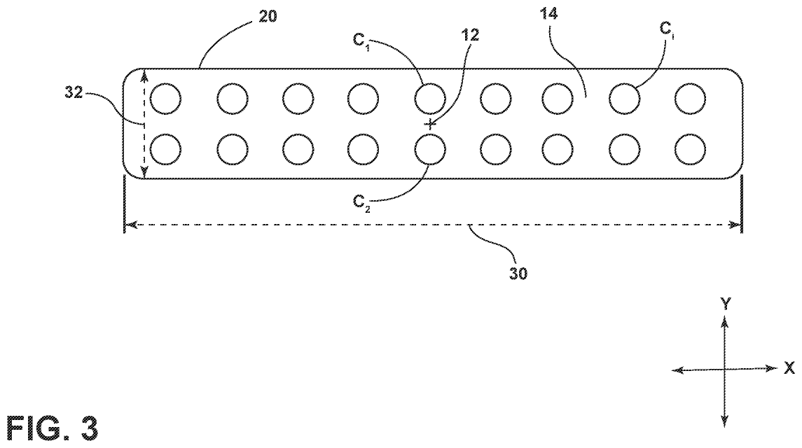

While FIGS. 1 and 2 illustrate the multicore optical fiber 10 as having a circular cross-sectional shape, the multicore optical fiber 10 can also be in the form of a ribbon having a rectangular or ribbon cross-sectional shape, as illustrated in FIG. 3. In some embodiments, the multicore optical fiber of the present disclosure can have a circular cross-section shape with seven cores, wherein six of the cores are at the vertices of a hexagon and the seventh core is at the center of the circular cross-section. In some embodiments, the multicore optical fiber of the present disclosure can have a circular cross-section and the cores can be arranged in a 2×2 configuration. In still other embodiments, the multicore optical fiber of the present disclosure can have a circular cross-section and the number of cores can be between 10 and 20. When in ribbon form, the multicore optical fiber 10 can have a cross-sectional width 30 and a thickness 32. The cores C, can be arranged in one or more rows along the thickness 32 and in one or more columns extending along the width 30. The position of each core Cᵢ and each core centerline CL₁ can be defined using a Cartesian coordinate axis system with respect to the central fiber axis 12, in a manner similar to that described above with respect to the circular multicore optical fiber 10 of FIGS. 1 and 2.

The multicore optical fiber 10 can have N number of total cores Cᵢ, wherein i=1 . . . N and N is at least 2. According to one aspect of the present disclosure, the total number N of cores Cr in the multicore optical fiber 10 is from 2 to 20, 2 to 18, 2 to 16, 2 to 12, 2 to 10, 2 to 8, 2 to 6, 2 to 4, 2 to 3, 4 to 20, 4 to 18, 4 to 16, 4 to 12, 4 to 10, 4 to 8, 4 to 6, 6 to 20, 6 to 18, 6 to 16, 6 to 12, 6 to 10, 6 to 8, 8 to 20, 8 to 18, 8 to 16, 8 to 12, 8 to 10, 10 to 20, 10 to 18, 10 to 16, 10 to 12, 12 to 20, 12 to 18, or 12 to 16. For example, the total number N of cores C in the multicore optical fiber 10 can be 2, 3, 4, 5, 6, 7, 8, 9, 10, 11, 12, 13, 14, 15, 16, 17, 18, 19, 20, or any total number N of cores Cᵢ between any of these values. The total number N of cores Cᵢ can be even or odd and can be arranged in any pattern within the cladding matrix 14, non-limiting examples of which include a 2×4 pattern (or multiples thereof), a square pattern, a rectangular pattern, a circular pattern, and a hexagonal lattice pattern. For example, the multicore optical fiber 10 can have N=7 cores Cᵢ arranged in a hexagonal lattice pattern. In another example, the multicore optical fiber 10 can have N=12 cores Cᵢ arranged in a circular pattern. In one example, the multicore optical fiber 10 can have a core Cᵢ positioned such that the core centerline CLᵢ aligns with the central fiber axis 12. In another example, the multicore optical fiber 10 can have a core Cᵢ pattern such that the cores Cᵢ are spaced around the central fiber axis 12.

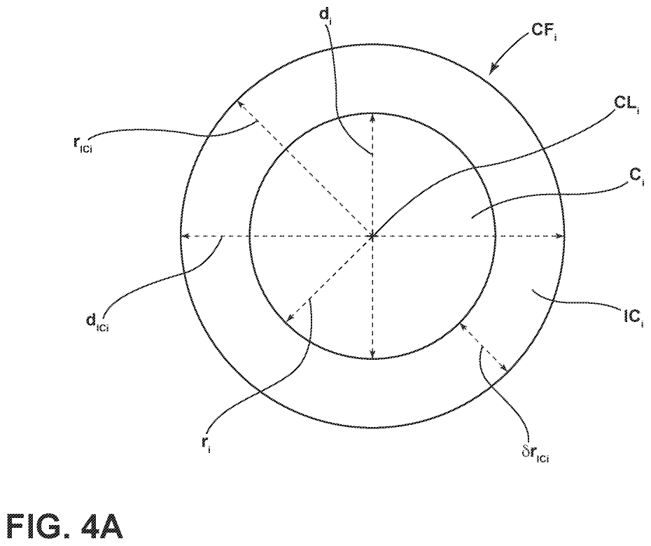

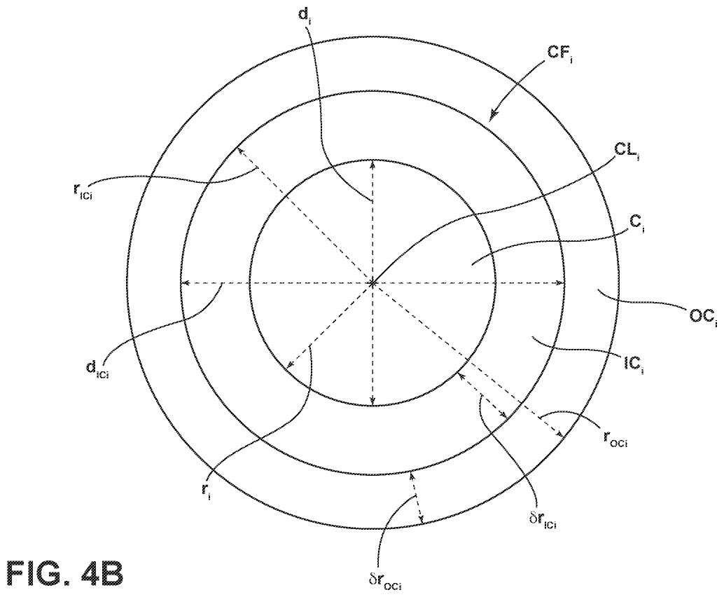

Referring now to FIG. 4A, according to one aspect of the present disclosure, one or more of the plurality of cores Cᵢ of the multicore optical fiber 10 can optionally be surrounded by an inner cladding ICᵢ. Each inner cladding IC has an outer radius r_{ICi} and an inner radius that corresponds to the outer radius rᵢ of the core Cᵢ. The inner cladding ICᵢ has a width δr_{ICi} defined by the outer radius rᵢ of the core C and the outer radius r_{ICi} of the inner cladding ICᵢ. The core Cᵢ can include a diameter dᵢ corresponding to 2*rᵢ and the inner cladding ICᵢ can include a diameter d_{ICi} corresponding to 2*r_{ICi}.

Referring now to FIG. 4B, according to one aspect of the present disclosure, one or more of the plurality of cores Cᵢ of the multicore optical fiber 10 can optionally be surrounded by an inner cladding ICᵢ and an outer cladding OC surrounding the inner cladding ICᵢ between the inner cladding ICᵢ and the common cladding 20. Each inner cladding ICᵢ has an outer radius r_{ICi} and an inner radius that corresponds to the outer radius rᵢ of the core Cᵢ. The inner cladding ICᵢ has a width δr_{IC1} defined by the outer radius rᵢ of the core Cᵢ and the outer radius r_{ICi} of the inner cladding ICᵢ. The core Cᵢ can include a diameter dᵢ corresponding to 2*rᵢ and the inner cladding ICᵢ can include a diameter d_{ICi} corresponding to 2*r_{ICi}. Each outer cladding OCᵢ has an outer radius r_{OCi} and an inner radius that corresponds to the outer radius r_{ICi} of the inner cladding ICᵢ. The outer cladding OCᵢ has a width δr_{OCi} defined by the outer radius r_{ICi} of the inner cladding ICᵢ and the outer radius δr_{OCi} of the outer cladding OCᵢ.

Referring again to FIGS. 1-3, the cladding matrix 14 forming the common cladding 20 can include undoped silica glass or doped silica glass. According to one aspect, the cladding matrix 14 is undoped silica glass. According to another aspect of the present disclosure, the cladding matrix 14 is doped silica glass that includes one or more up-dopants and/or one or more down-dopants. As used herein, the term “up-dopant” is used to refer to a dopant that increases the refractive index relative to pure, undoped silica glass. Non-limiting examples of up-dopants include chlorine (“Cl”), bromine (“Br”), germanium dioxide (“GeO₂”), aluminum trioxide (“Al₂O₃”), phosphorus pentoxide (“P₂O⁵”), and titanium dioxide (“TiO₂”). As used herein, the term “down-dopant” is used to refer to a dopant that decreases the refractive index relative to pure, undoped silica glass. Non-limiting examples of down-dopants include fluorine (“F”) and boron (“B”). In one example, the core can be up-doped with GeO₂. In another example, the inner and/or common cladding can be down-doped with fluorine. In another example, the inner and/or common cladding can be up-doped with chlorine.

For some dopants, the change in refractive index relative to undoped silica glass varies linearly as a function of dopant concentration. For example, up-doping with GeO₂ can result in a relative refractive index due to Ge (“ΔGe %”) that can be estimated as a function of concentration of GeO₂, in weight percent (“wt % of GeO₂”), by the following equation: ΔGe %=0.0601*(wt % of GeO₂). In another example, down-doping with fluorine can result in a relative refractive index due to F (“ΔF %”) that can be estimated as a function of concentration of F, in weight percent (“wt % of F”), by the following equation: ΔF %=−0.3053*(wt % of F). In another example, up-doping with chlorine can result in a relative refractive index due to Cl (“ΔCl %”) that can be estimated as a function of concentration of Cl, in weight percent (“wt % of Cl”), by the following equation: ΔCl %=0.10*(wt % of Cl).

The amount of dopant in the silica glass can be selected to provide the common cladding 20 with one or more desired characteristics, non-limiting examples of which include a relative refractive index and a viscosity. According to one aspect of the present disclosure, the common cladding 20 includes silica glass doped with chlorine. In one example, an amount of chlorine dopant in the silica glass is from about 0 wt % to about 2 wt %, about 0.01 wt % to about 2 wt %, about 0.1 wt % to about 2 wt %, about 0.5 wt % to about 2 wt %, about 1 wt % to about 2 wt %, about 1.5 wt % to about 2 wt %, 0 wt % to about 1.5 wt %, about 0.01 wt % to about 1.5 wt %, about 0.1 wt % to about 1.5 wt %, about 0.5 wt % to about 1.5 wt %, about 1 wt % to about 1.5 wt %, 0 wt % to about 1 wt %, about 0.01 wt % to about 1 wt %, about 0.1 wt % to about 1 wt %, about 0.5 wt % to about 1 wt %, 0 wt % to about 0.5 wt %, about 0.01 wt % to about 0.5 wt %, or about 0.1 wt % to about 0.5 wt %. According to one aspect of the present disclosure, the common cladding 20 includes silica glass doped with fluorine. In one example, an amount of fluorine dopant in the silica glass is from about 0 wt % to about 2 wt %, about 0.01 wt % to about 2 wt %, about 0.1 wt % to about 2 wt %, about 0.5 wt % to about 2 wt %, about 1 wt % to about 2 wt %, about 1.5 wt % to about 2 wt %, 0 wt % to about 1.5 wt %, about 0.01 wt % to about 1.5 wt %, about 0.1 wt % to about 1.5 wt %, about 0.5 wt % to about 1.5 wt %, about 1 wt % to about 1.5 wt %, 0 wt % to about 1 wt %, about 0.01 wt % to about 1 wt %, about 0.1 wt % to about 1 wt %, about 0.5 wt % to about 1 wt %, 0 wt % to about 0.5 wt %, about 0.01 wt % to about 0.5 wt %, or about 0.1 wt % to about 0.5 wt %.

The common cladding 20 can have a relative refractive index Δ_{CC} of from about −0.25% to about 0.3%. For example, the common cladding 20 can have a relative refractive index Δ_{CC} of from about −0.25% to about 0.3%, about −0.2% to about 0.3%, about −0.15% to about 0.3%, about −0.1% to about 0.3%, about −0.05% to about 0.3%, about −0.025% to about 0.3%, about 0% to about 0.3%, about 0.025% to about 0.3%, about 0.05% to about 0.3%, about −0.25% to about 0.2%, about −0.2% to about 0.2%, about −0.15% to about 0.2%, about −0.1% to about 0.2%, about −0.05% to about 0.2%, about −0.025% to about 0.2%, about 0% to about 0.2%, about 0.025% to about 0.2%, about 0.05% to about 0.2%, about −0.25% to about 0.1%, about −0.2% to about 0.1%, about −0.15% to about 0.1%, about −0.1% to about 0.1%, about −0.05% to about 0.1%, about −0.025% to about 0.1%, about 0% to about 0.1%, about 0.025% to about 0.1%, about 0.05% to about 0.1%, about −0.25% to about 0.05%, about −0.2% to about 0.05%, about −0.15% to about 0.05%, about −0.1% to about 0.05%, about −0.05% to about 0.05%, about −0.025% to about 0.05%, about 0% to about 0.05%, about 0.025% to about 0.05%, about −0.25% to about 0.025%, about −0.2% to about 0.025%, about −0.15% to about 0.025%, about −0.1% to about 0.025%, about −0.05% to about 0.025%, about −0.025% to about 0.025%, about 0% to about 0.025%, about −0.25% to about 0%, about −0.2% to about 0%, about −0.15% to about 0%, about −0.1% to about 0%, about −0.05% to about 0%, or about −0.025% to about 0%.

When the multicore optical fiber 10 has a circular cross-sectional shape, the common cladding 20 can have an outer radius R_{CC} less than or equal to about 110 μm (≤110 μm). For example, the outer radius R_{CC} can be ≤110 μm, ≤100 μm, ≤95 μm, or ≤90 μm. In some examples, the outer radius R_{CC} can be from about 50 μm to about 110 μm. For example, the common cladding 20 can have an outer radius R_{CC} of from about 50 μm to about 110 μm, about 60 μm to about 110 μm, about 75 μm to about 110 μm, about 100 μm to about 110 μm, about 50 μm to about 100 μm, about 60 μm to about 100 μm, about 75 μm to about 100 μm, about 50 μm to about 95 μm, about 60 μm to about 95 μm, about 75 μm to about 95 μm, about 50 μm to about 90 μm, about 60 μm to about 90 μm, or about 75 μm to about 90 μm. In one example, the outer radius R_{CC} of the common cladding 20 is about 50 μm, about 60 μm, about 62 μm, about 62.5 μm, about 63 μm, about 70 μm, about 80 μm, about 90 μm, about 100 μm, about 110 μm, or any length between these values.

When the multicore optical fiber 10 is in the form of a ribbon having a rectangular or ribbon cross-sectional shape, the outer core 20 can have a width 30 of from about 50 μm to about 400 μm. According to one aspect, the outer core 20 can have a width 30 of from about 50 μm to about 400 μm, about 100 μm to about 400 μm, about 150 μm to about 400 μm, about 200 μm to about 400 μm, about 250 μm to about 400 μm, about 300 μm to about 400 μm, about 350 μm to about 400 μm, 50 μm to about 350 μm, about 100 μm to about 350 μm, about 150 μm to about 350 μm, about 200 μm to about 350 μm, about 250 μm to about 350 μm, about 300 μm to about 350 μm, 50 μm to about 300 μm, about 100 μm to about 300 μm, about 150 μm to about 300 μm, about 200 μm to about 300 μm, about 250 μm to about 300 μm, 50 μm to about 250 μm, about 100 μm to about 250 μm, about 150 μm to about 250 μm, about 200 μm to about 250 μm, 50 μm to about 200 μm, about 100 μm to about 200 μm, about 150 μm to about 200 μm, 50 μm to about 150 μm, about 100 μm to about 150 μm, or about 50 μm to about 125 μm. In another example, the width 30 of the common cladding 20 is less than 200 μm, less than 170 μm, less than 160 μm, less than 140 μm, less than 120 μm, or less than 130 μm.

According to an aspect of the present disclosure, each of the cores Cᵢ includes silica glass doped with greater than 3 wt % chlorine. The chlorine doping in each of the cores Cᵢ may be the same or different. In one aspect, the cores Cᵢ can include silica glass doped with chlorine in an amount greater than 3 wt %, greater than 3.25 wt %, greater than 3.5 wt %, greater than 3.75 wt %, greater than 4 wt %, greater than 4.25 wt %, greater than 4.5 wt %, greater than 4.75 wt %, greater than 5 wt %, greater than 5.25 wt %, greater than 5.5 wt %, or greater than 6 wt %. For example, the cores C, can include silica glass doped with chlorine in an amount of from about 3 wt % to about 6 wt %, about 3.25 wt % to about 6 wt %, about 3.5 wt % to about 6 wt %, about 3.75 wt % to about 6 wt %, about 4 wt % to about 6 wt %, about 4.25 wt % to about 6 wt %, about 4.5 wt % to about 6 wt %, about 4.75 wt % to about 6 wt %, about 5 wt % to about 6 wt %, about 5.25 wt % to about 6 wt %, about 5.5 wt % to about 6 wt %, about 5.75 wt % to about 6 wt %, about 3 wt % to about 5 wt %, about 3.25 wt % to about 5 wt %, about 3.5 wt % to about 5 wt %, about 3.75 wt % to about 5 wt %, about 4 wt % to about 5 wt %, about 4.25 wt % to about 5 wt %, about 4.5 wt % to about 5 wt %, about 4.75 wt % to about 5 wt %, about 3 wt % to about 4 wt %, about 3.25 wt % to about 4 wt %, about 3.5 wt % to about 4 wt %, or about 3.75 wt % to about 4 wt %. For example, the cores Cᵢ can include silica glass doped with chlorine in an amount of about 3 wt %, about 3.1 wt %, about 3.17 wt %, about 3.2 wt %, about 3.25 wt %, about 3.3 wt %, about 3.4 wt %, about 3.5 wt %, about 3.75 wt %, about 4 wt %, about 4.25 wt %, about 4.5 wt %, about 4.75 wt %, about 5 wt %, about 5.25 wt %, about 5.3 wt %, about 5.4 wt %, about 5.5 wt %, about 5.75 wt %, about 6 wt %, or any amount of chlorine between these values.

According to one aspect of the present disclosure, the cores Cᵢ include silica glass doped with chlorine and are free or substantially free of any other dopants. As used herein, free or substantially free are used interchangeably to mean that no additional dopants are intentionally added to the cores Cᵢ, although it is understood that trace amounts of other materials may be present due to impurities and/or contaminants in source materials and/or processing equipment.

The cores Cᵢ can have a relative refractive index Δ_{iMAX} of about 0.15% to about 0.5%. Each of the cores Cᵢ can have the same or different relative refractive index Δ_{iMAX}. In one aspect, the cores Cᵢ can have a relative refractive index Δ_{iMAX} of about 0.15% to about 0.5%, about 0.2% to about 0.5%, about 0.25% to about 0.5%, about 0.3% to about 0.5%, about 0.325% to about 5%, about 0.35% to about 5%, about 0.15% to about 0.4%, about 0.2% to about 0.4%, about 0.25% to about 0.4%, about 0.3% to about 0.4%, about 0.325% to about 4%, about 0.35% to about 4%, about 0.15% to about 0.35%, about 0.2% to about 0.35%, about 0.25% to about 0.35%, about 0.3% to about 0.35%, about 0.325% to about 0.35%, about 0.15% to about 0.325%, about 0.2% to about 0.325%, about 0.25% to about 0.325%, about 0.3% to about 0.325%, or about 0.15% to about 0.25%. In one example, the cores Cᵢ can have a relative refractive index Δ_{iMAX} of greater than 0.15%, greater than 0.2%, greater than 0.25%, greater than 0.3%, greater than 0.325%, greater than 0.35%, or greater than 0.4%. In one example, the cores Cᵢ can have a relative refractive index Δ_{iMAX} of about 0.15%, about 0.2%, about 0.25%, about 0.3%, about 0.325%, about 0.34%, about 0.35%, about 0.4%, about 0.45%, about 0.5%, or any relative refractive index Δ_{iMAX} between these values.

According to an aspect of the present disclosure, the cores Cᵢ can have a core alpha a of about 1≤α≤100. The cores C can each have the same or different core alpha. For example, the cores Cᵢ can have a core alpha a of about 1≤α≤about 100, about 10≤α≤about 100, about 10≤α≤about 50, about 10≤α≤about 20, about 1≤α≤about 8, about 2≤α≤about 6, or about 2≤α≤about 4. In one example, the cores Cᵢ can have a core alpha a of about 20. In another example, the cores Cᵢ can have a core alpha a of about 2.5.

According to an aspect of the present disclosure, the cores Cᵢ can have an outer core radius rᵢ of from about 2.5 μm to about 12.5 μm. Each of the cores Cᵢ can have the same or different outer core radius rᵢ. In one example, the cores Cᵢ can have an outer core radius rᵢ of from about 2.5 μm to about 12.5 μm, about 5.0 μm to about 12.5 μm, about 10 μm to about 12.5 μm, about 2.5 μm to about 10 μm, about 5 μm to about 10 μm, or about 2.5 μm to about 5 μm. In one example, the cores Cᵢ can have an outer core radius rᵢ of about 2.5 μm, about 3 μm, about 4 μm, about 4.2 μm, about 4.5 μm, about 4.9 μm, about 5 μm, about 5.5 μm, about 6 μm, about 6.5 μm, about 7 μm, about 7.3 μm, about 7.4 μm, about 8 μm, about 10 μm, about 12.5 μm, or any outer core radius rᵢ between these values. The cores Cᵢ can be single mode or multimode depending on the operating wavelength of the multicore optical fiber 10.

According to an aspect of the present disclosure, a distance between the centerline CLᵢ of a given core Cᵢ and the centerline CLⱼ of an adjacent core Cⱼ is greater than 10 μm, as measured using a Cartesian coordinate system in which the central fiber axis 12 defines the origin (0, 0) of the coordinate system. For a given core Cᵢ having a centerline CLᵢ and an adjacent core Cⱼ having a centerline CLⱼ, a distance D_{Ci-Cj} is defined as √[(xⱼ−xᵢ)²+(yⱼ−yᵢ)²]. For example, a distance D_{Ci-Cj} between adjacent cores can be greater than 10 μm, greater than 15 μm, greater than 20 μm, greater than 25 μm, greater than 28 μm, or greater than 30 μm. For example, a distance D_{Ci-Cj} between adjacent cores can be from about 10 μm to about 50 μm, about 10 μm to about 40 μm, about 10 μm to about 30 μm, about 10 μm to about 20 μm, about 20 μm to about 50 μm, about 20 μm to about 40 μm, about 20 μm to about 30 μm, about 28 μm to about 50 μm, about 28 μm to about 40 μm, about 28 μm to about 30 μm, about 30 μm to about 50 μm, about 30 μm to about 40 μm, or about 40 μm to about 50 μm. The distance D_{Ci-Cj} between adjacent cores can be the same or different for each of the cores of the multicore optical fiber 10.

According to an aspect of the present disclosure, the multicore optical fiber 10 can include an inner cladding ICi, such as illustrated in the exemplary embodiment of FIG. 4A. When present, the inner cladding ICᵢ can include silica glass doped with fluorine or undoped silica. In some aspects, the inner cladding ICᵢ can include silica glass doped with fluorine in an amount of from about 0 wt % to about 0.5 wt %. For example, the inner cladding ICᵢ can include silica glass doped with fluorine in an amount of from about 0 wt % to about 0.5 wt %, about 0.1 wt % to about 0.5 wt %, about 0.1 wt % to about 0.4 wt %, about 0.1 wt % to about 0.3 wt %, about 0.1 wt % to about 0.2 wt %, about 0.2 wt % to about 0.5 wt %, about 0.2 wt % to about 0.4 wt %, about 0.2 wt % to about 0.3 wt %, about 0.3 wt % to about 0.5 wt %, or about 0.3 wt % to about 0.4 wt %. For example, the inner cladding ICᵢ can include silica glass doped with fluorine in an amount of about 0 wt %, about 0.1 wt %, about 0.15 wt %, about 0.17 wt %, about 0.2 wt %, about 0.23 wt %, about 0.25 wt %, about 0.3 wt %, about 0.35 wt %, about 0.4 wt %, about 0.45 wt %, about 0.5 wt %, or any amount of fluorine between these values. Each inner cladding ICᵢ can have the same or different amount of fluorine doping.

In some aspects, when the common cladding 20 includes silica glass doped with an up-dopant, such as chlorine, for example, the inner cladding IC can include undoped silica glass. In another example, the common cladding 20 can include silica glass doped with a down-dopant, such as fluorine, for example, and the inner cladding ICᵢ can include undoped silica glass. In this manner, the inner cladding IC can be defined as a region surrounding the core Cᵢ and between the core Cᵢ and the common cladding 20 in which the relative refractive index Δ_{ICi} of the inner cladding ICᵢ is less than the relative refractive index core Δ_{iMAX} of the core Cᵢ and different than the relative refractive index Δ_{CC} of the common cladding 20. For example, the relative refractive index Δ_{CC} of the common cladding 20 can be less than or greater than the relative refractive index Δ_{ICi} of each inner cladding ICᵢ. In some examples, the relative refractive index Δ_{CC} of the common cladding 20 is greater than the relative refractive index Δ_{ICi} of one or more of the inner claddings ICᵢ. In some examples, the relative refractive index Δ_{CC} of the common cladding 20 is less than the relative refractive index Δ_{ICi} of one or more of the inner claddings ICᵢ.

Still referring to the exemplary embodiment of FIG. 4A, according to an aspect of the present disclosure the inner cladding ICᵢ can be characterized by a relative refractive index Δ_{ICi}≤0. Each inner cladding ICᵢ can have the same or different relative refractive index Δ_{ICi}. The relative refractive index Δ_{ICi} of the inner cladding ICᵢ is less than the relative refractive index Δ_{iMAX} of the core Cᵢ which the corresponding inner cladding ICᵢ surrounds. According to one aspect, a relative refractive index Δ_{ICi} of the inner cladding ICᵢ is from about −0.2% to about 0%. For example, the inner cladding ICᵢ can be characterized by a relative refractive index Δ_{ICi} of from about −0.7% to about 0%, about −0.6% to about 0%, about −0.5% to about 0%, about −0.4% to about 0%, about −0.3% to about 0%, about −0.2% to about 0%, −0.18% to about 0%, about −0.15% to about 0%, about −0.12% to about 0%, about −0.1% to about 0%, about −0.08% to about 0%, about −0.05% to about 0%, about −0.02% to about 0%, about −0.7% to about −0.1%, about −0.6% to about −0.1%, about −0.5% to about −0.1%, about −0.4% to about −0.1%, about −0.3% to about −0.1%, about −0.7% to about −0.2%, about −0.6% to about −0.2%, about −0.5% to about −0.2%, about −0.4% to about −0.2%, about −0.3% to about −0.2%, about −0.2% to about −0.02%, −0.18% to about −0.02%, about −0.15% to about −0.02%, about −0.12% to about −0.02%, about −0.1% to about −0.02%, about −0.08% to about −0.02%, about −0.05% to about −0.02%, about −0.2% to about −0.05%, −0.18% to about −0.05%, about −0.15% to about −0.05%, about −0.12% to about −0.05%, about −0.1% to about −0.05%, about −0.08% to about −0.05%, about −0.2% to about −0.08%, −0.18% to about −0.08%, about −0.15% to about −0.08%, about −0.12% to about −0.08%, about −0.1% to about −0.08%, about −0.2% to about −0.1%, −0.18% to about −0.1%, about −0.15% to about −0.1%, or about −0.12% to about −0.1%. For example, the inner cladding ICᵢ can be characterized by a relative refractive index Δ_{ICi} of about −0.7%, about −0.6%, about −0.5%, about −0.4%, about −0.3%, about −0.2%, about −0.18%, about −0.15%, about −0.12%, about −0.1%, about −0.08%, about −0.07%, about −0.05%, about −0.02%, about −0.01%, or any relative refractive index between these values.

Still referring to the exemplary embodiment of FIG. 4A, according to an aspect of the present disclosure, the inner cladding ICᵢ can have a width δr_{ICi} of from about 5 μm to about 30 μm. The width δr_{ICi} of each inner cladding ICᵢ can be the same or different. In one aspect, the inner cladding ICᵢ can have a width δr_{ICi} of from about 5 μm to about 30 μm, about 10 μm to about 30 μm, about 15 μm to about 30 μm, about 20 μm to about 30 μm, about 25 μm to about 30 μm, about 5 μm to about 25 μm, about 10 μm to about 25 μm, about 15 μm to about 25 μm, about 20 μm to about 25 μm, about 5 μm to about 20 μm, about 10 μm to about 20 μm, about 15 μm to about 20 μm, about 5 μm to about 15 μm, or about 10 μm to about 15 μm. For example, the inner cladding ICᵢ can have a width δr_{ICi} of about 5 μm, about 10 μm, about 15 μm, about 15.8 μm, about 16 μm, about 17 μm, about 17.6 μm, about 17.7 μm, about 20 μm, about 22 μm, about 25 μm, about 27 μm, about 30 μm, or any width between these values. As discussed above, the width δr_{ICi} of the inner cladding ICᵢ can be defined as a distance between the outer radius r_{ICi} of the inner cladding ICᵢ and the inner radius of the inner cladding ICᵢ, which corresponds to the outer radius rᵢ of the core Cᵢ that is surrounded by the inner cladding ICᵢ.

Still referring to the exemplary embodiment of FIG. 4A, according to an aspect of the present disclosure, the inner cladding ICᵢ can have a trench volume of greater than about 30%Δ-square micrometers. In one aspect, the inner cladding ICᵢ can have a trench volume of greater than about 30%Δ-square micrometers, greater than about 40%Δ-square micrometers, greater than about 50%Δ-square micrometers, or greater than about 60%Δ-square micrometers. In some aspects, the inner cladding ICᵢ can have a trench volume of less than about 75%Δ-square micrometers, less than about 70%Δ-square micrometers, less than about 65%Δ-square micrometers, or less than about 60%Δ-square micrometers. In some aspects, the inner cladding ICᵢ can have a trench volume of from about 30%Δ-square micrometers to about 120%Δ-square micrometers, about 40%Δ-square micrometers to about 120%Δ-square micrometers, about 50%Δ-square micrometers to about 120%Δ-square micrometers, about 60%Δ-square micrometers to about 120%Δ-square micrometers, about 70%Δ-square micrometers to about 120%Δ-square micrometers, about 80%Δ-square micrometers to about 120%Δ-square micrometers, about 90%Δ-square micrometers to about 120%Δ-square micrometers, about 100%Δ-square micrometers to about 120%Δ-square micrometers, about 110%Δ-square micrometers to about 120%Δ-square micrometers, about 30%Δ-square micrometers to about 110%Δ-square micrometers, about 40%Δ-square micrometers to about 110%Δ-square micrometers, about 50%Δ-square micrometers to about 110%Δ-square micrometers, about 60%Δ-square micrometers to about 110%Δ-square micrometers, about 70%Δ-square micrometers to about 110%Δ-square micrometers, about 80%Δ-square micrometers to about 110%Δ-square micrometers, about 90%Δ-square micrometers to about 110%Δ-square micrometers, about 100%Δ-square micrometers to about 110%Δ-square micrometers, about 30%Δ-square micrometers to about 100%Δ-square micrometers, about 40%Δ-square micrometers to about 100%Δ-square micrometers, about 50%Δ-square micrometers to about 100%Δ-square micrometers, about 60%Δ-square micrometers to about 100%Δ-square micrometers, about 70%Δ-square micrometers to about 100%Δ-square micrometers, or about 80%Δ-square micrometers to about 100%Δ-square micrometers. For example, the inner cladding ICᵢ can have a trench volume of about 30%Δ-square micrometers, about 40%Δ-square micrometers, about 50%Δ-square micrometers, about 55%Δ-square micrometers, about 57%Δ-square micrometers, about 60% Δ-square micrometers, about 62% Δ-square micrometers, about 70% Δ-square micrometers, about 80% Δ-square micrometers, about 90% Δ-square micrometers, about 100% Δ-square micrometers, about 107% Δ-square micrometers, about 110% Δ-square micrometers, about 120% Δ-square micrometers, or any trench volume between these values. Each inner cladding ICᵢ can have the same or different trench volume. The trench volume of the inner cladding ICᵢ can be determined as described above wherein r_{IC,inner} corresponds to the inner radius of the inner cladding ICᵢ, which corresponds to the outer radius rᵢ of the core Cᵢ that is surrounded by the inner cladding ICᵢ and r_{IC,outer} corresponds to the outer radius r_{ICi} of the inner cladding ICᵢ.

According to an aspect of the present disclosure, the multicore optical fiber 10 can include a core Cᵢ having an inner cladding ICᵢ and an outer cladding OCᵢ, an exemplary embodiment of which is illustrated in FIG. 4B. The inner cladding ICi can include undoped silica, silica glass doped with an up-dopant, such as chlorine, or silica glass doped with a down-dopant, such as fluorine. The material of the inner cladding ICᵢ can be selected such that the relative refractive index Δ_{ICi} of the inner cladding ICᵢ is less than the relative refractive index Δ_{iMAX} of the core Cᵢ and greater than the relative refractive index Δ_{OCi} of the outer cladding OCᵢ which surrounds the corresponding inner cladding ICᵢ. The outer cladding OCᵢ can include undoped silica, silica glass doped with an up-dopant, such as chlorine, or silica glass doped with a down-dopant, such as fluorine. The outer cladding OCᵢ defines a depressed refractive index region (also referred to as a trench), that is offset from the core Cᵢ (also referred to as an offset trench). The outer cladding OCᵢ can be made by either down doping the outer cladding OCᵢ relative to the inner cladding ICᵢ and the common cladding 20 or by up-doping the inner cladding ICᵢ and the common cladding 20 relative to the outer cladding OCᵢ. In one exemplary embodiment, the relative refractive index Δ_{ICi} of the inner cladding ICᵢ≥0 and is less than the relative refractive index Δ_{iMAX} of the core Cᵢ and greater than the relative refractive index Δ_{OCi} of the outer cladding OCᵢ, where Δ_{CC}>Δ_{OCi}. In one example, the relative refractive index Δ_{OCi} can be ≤0. In another exemplary embodiment, the relative refractive index Δ_{ICi} of the inner cladding ICᵢ and the common cladding Δ_{CC} is 0 and the relative refractive index Δ_{OCi} of the outer cladding OCᵢ<0. The relative refractive index Δ_{ICi} of the inner cladding ICᵢ and the common cladding Δ_{CC} can be the same or different.

Still referring to the exemplary embodiment of FIG. 4B, according to an aspect of the present disclosure the inner cladding ICᵢ can be characterized by a relative refractive index Δ_{ICi}≤0 or a relative refractive index Δ_{ICi}≥0. Each inner cladding ICᵢ can have the same or different relative refractive index Δ_{ICi}. The relative refractive index Δ_{ICi} of the inner cladding ICᵢ is less than the relative refractive index Δ_{iMAX} of the core Cᵢ which the corresponding inner cladding ICᵢ surrounds. According to one aspect, a relative refractive index Δ_{ICi} of the inner cladding ICᵢ is from about −0.05% to about 0.05%. For example, the inner cladding ICᵢ can be characterized by a relative refractive index Δ_{ICi} of from about −0.05% to about 0.05%, about −0.04% to about 0.04%, about −0.03% to about 0.03%, about −0.02% to about 0.02%, about −0.01% to about 0.01%, or about 0%. For example, the inner cladding ICᵢ can be characterized by a relative refractive index Δ_{ICi} of about −0.05%, about −0.04%, about −0.03%, about −0.02%, about −0.01%, about 0%, about 0.01%, about 0.02%, about 0.03%, about 0.04%, about 0.05%, or any relative refractive index between these values.

In some embodiments, the inner cladding ICᵢ can include undoped silica glass. In other embodiments, the inner cladding ICᵢ can include silica glass doped with fluorine (to decrease the relative refractive index) or silica glass doped with chlorine (to increase the relative refractive index) to provide the desired relative refractive index. For example, the inner cladding ICᵢ can include silica glass doped with fluorine in an amount of from about 0 wt % to about 0.16 wt %. For example, the inner cladding ICᵢ can include silica glass doped with fluorine in an amount of from about 0 wt % to about 0.16 wt %, about 0 wt % to about 0.13 wt %, about 0 wt % to about 0.1 wt %, about 0 wt % to about 0.06 wt %, or about 0 wt % to about 0.03 wt %. In another example, the inner cladding ICᵢ can include silica glass doped with chlorine in an amount of from about 0 wt % to about 0.5 wt %, about 0 wt % to about 0.4 wt %, about 0 wt % to about 3 wt %, about 0 wt % to about 2 wt %, or about 0 wt % to about 1 wt %. Each inner cladding ICᵢ can have the same or different amount of doping.

Still referring to the exemplary embodiment of FIG. 4B, according to an aspect of the present disclosure, the inner cladding ICᵢ can have a width δr_{ICi} of from about 5 μm to about 30 μm. The width δr_{ICi} of each inner cladding ICᵢ can be the same or different. In one aspect, the inner cladding ICᵢ can have a width δr_{ICi} of from about 5 μm to about 20 μm, about 10 μm to about 20 μm, about 15 μm to about 20 μm, about 5 μm to about 15 μm, about 5 μm to about 10 μm, or about 10 μm to about 15 μm. For example, the inner cladding IC can have a width δr_{ICi} of about 5 μm, about 6 μm, about 7 μm, about 8 μm, about 9 μm, about 10 μm, about 11 μm, about 12 μm, about 13 μm, about 14 μm, about 15 μm, about 20 μm, or any width between these values.

Still referring to the exemplary embodiment of FIG. 4B, according to an aspect of the present disclosure, the outer cladding OCᵢ can include undoped silica glass, silica glass doped with fluorine, or silica glass doped with chlorine to provide an outer cladding region having a depressed relative refractive index Δ_{OCi} relative to the adjacent inner cladding IC and the common cladding 20. For example, when one or both of the inner cladding ICᵢ and the common cladding 20 include undoped silica glass or silica glass doped with fluorine, the outer cladding OCᵢ can include silica glass doped with fluorine in an amount such that Δ_{OCi}<Δ_{ICi} and Δ_{OCi}<Δ_{CC}. In another example, when both of the inner cladding ICᵢ and the common cladding 20 include silica glass doped with chlorine, the outer cladding OC can include undoped silica glass, silica glass doped with fluorine, or silica glass doped with chlorine in an amount such that Δ_{OCi}<Δ_{ICi} and Δ_{OCi}<Δ_{CC}.

In one example, the outer cladding OCᵢ can include silica glass doped with fluorine in an amount of from about 0 wt % to about 3 wt %. For example, the outer cladding OCᵢ can include from about 0 wt % to about 3 wt %, about 0 wt % to about 2 wt %, about 0 wt % to about 1 wt %, about 0 wt % to about 0.5 wt %, about 0.5 wt % to about 3 wt %, about 0.5 wt % to about 2 wt %, about 0.5 wt % to about 1 wt %, about 1 wt % to about 3 wt %, about 1 wt % to about 2 wt %, or about 2 wt % to about 3 wt %. For example, the outer cladding OCᵢ can include about 0 wt %, about 0.5 wt %, about 0.8 wt %, about 1 wt %, about 1.1 wt %, about 1.3 wt %, about 2 wt %, about 3 wt %, or any amount of fluorine between these values. Each outer cladding OCᵢ can have the same or different amount of fluorine doping.

Still referring to the exemplary embodiment of FIG. 4B, the outer cladding OCᵢ has a relative refractive index that is less than the adjacent inner cladding ICi that the outer cladding OCᵢ surrounds and less than the common cladding 20. Each outer cladding OCᵢ can have the same or different relative refractive index. In one aspect, the outer cladding OCᵢ can have a relative refractive index Δ_{OCi}≤0%. For example, the outer cladding OCᵢ can have a relative refractive index Δ_{OCi} of from about −1% to about 0%, about −0.75% to about 0%, about −0.5% to about 0%, about −0.25% to about 0%, about −1% to about −0.25%, about −0.75% to about −0.25%, about −0.5% to about −0.25%, about −1% to about −0.5%, or about −0.75% to about −0.5%. For example, the outer cladding OCᵢ can have a relative refractive index Δ_{OCi} of about 0%, about −0.25%, about −0.26%, about −0.3%, about −0.33%, about −0.4%, about −0.5%, about −0.75%, about −1%, or any relative refractive index between these values.

Still referring to the exemplary embodiment of FIG. 4B, the outer cladding OCᵢ can have a width δr_{OCi} of from about 2 μm to about 20 μm. The width &cc, of each outer cladding OCi can be the same or different. In one aspect, the outer cladding OCᵢ can have a width δroc, of from about 2 μm to about 20 μm, about 2 μm to about 15 μm, about 2 μm to about 10 μm, about 2 μm to about 8 μm, about 3 μm to about 20 μm, about 3 μm to about 15 μm, about 3 μm to about 10 μm, about 3 μm to about 8 μm, about 4 μm to about 20 μm, about 4 μm to about 15 μm, about 4 μm to about 10 μm, about 4 μm to about 8 μm, about 10 μm to about 20 μm, about 10 μm to about 15 μm, or about 15 μm to about 20 μm. For example, the outer cladding OCᵢ can have a width δ_{OCi} of about 2 μm, about 3 μm, about 4 μm, about 5 μm, about 6 μm, about 7 μm, about 8 μm, about 9 μm, 10 μm, about 12 μm, about 15 μm, about 16 μm, about 17 μm, about 18 μm, about 19 μm, about 20 μm, or any width between these values.

In one aspect, the outer cladding OCᵢ can be characterized by a trench volume of greater than about 30% Δ-square micrometers. In one aspect, the outer cladding OCᵢ can have a trench volume of greater than about 30% Δ-square micrometers, greater than about 40% Δ-square micrometers, greater than about 50% Δ-square micrometers, or greater than about 60% Δ-square micrometers. In some aspects, the outer cladding OCᵢ can have a trench volume of less than about 75% Δ-square micrometers, less than about 70% Δ-square micrometers, less than about 65% Δ-square micrometers, or less than about 60% Δ-square micrometers. In some aspects, the outer cladding OCᵢ can have a trench volume of from about 30% Δ-square micrometers to about 75% Δ-square micrometers, about 40% Δ-square micrometers to about 75% Δ-square micrometers, about 50% Δ-square micrometers to about 75% Δ-square micrometers, about 60% Δ-square micrometers to about 75% Δ-square micrometers, about 30% Δ-square micrometers to about 65% Δ-square micrometers, about 40% Δ-square micrometers to about 65% Δ-square micrometers, about 50% Δ-square micrometers to about 65% Δ-square micrometers, about 30% Δ-square micrometers to about 55% Δ-square micrometers, or about 40% Δ-square micrometers to about 55% Δ-square micrometers. For example, the outer cladding OCᵢ can have a trench volume of about 30% Δ-square micrometers, about 40% Δ-square micrometers, about 45% Δ-square micrometers, about 46% Δ-square micrometers, about 47% Δ-square micrometers, about 48% Δ-square micrometers, about 49% Δ-square micrometers, about 50% Δ-square micrometers, about 55% Δ-square micrometers, about 60% Δ-square micrometers, about 61% Δ-square micrometers, about 62% Δ-square micrometers, about 68% Δ-square micrometers, about 69% Δ-square micrometers, about 70% Δ-square micrometers, about 75% Δ-square micrometers, or any trench volume between these values. Each outer cladding OCᵢ can have the same or different trench volume. The trench volume of the outer cladding OCᵢ can be determined as described above.

The multicore optical fiber 10 can be characterized by crosstalk between adjacent cores Cᵢ of equal to or less than −20 dB, as measured for a 100 km length of the multicore optical fiber 10 operating at 1550 nm. In some aspects, the multicore optical fiber 10 can be characterized by crosstalk between adjacent cores Cᵢ of equal to or less than −30 dB, as measured for a 100 km length of the multicore optical fiber 10. In some aspects, crosstalk between adjacent cores Cᵢ is ≤−20 dB, ≤−30 dB, ≤−40 dB, ≤−50 dB, or ≤−60 dB, as measured for a 100 km length of the multicore optical fiber 10 operating at 1550 nm. The crosstalk can be determined based on the coupling coefficient, which depends on the design of the core and a distance between two adjacent cores, and Δβ, which depends on a difference in β values between the two adjacent cores. For two cores placed next to each other, assuming the power launched into the first core is P₁, using coupled mode theory and considering the perturbations along the fiber, the power coupled to the second core, P₂, can be determined using the following equation (7):

$${P}_{2} = \frac{L}{{L}_{c}} 〈 {( \frac{κ}{g} )}^{2} {sin}^{2} ( g Δ L ) 〉 {P}_{1} \qquad ( 7 )$$

where < > denotes the average, L is fiber length, κ is the coupling coefficient, ΔL is the length of the fiber segment over which the fiber is uniform, L_{c} is the correlation length, and g is given by the following equation (8):

$${g}^{2} = {κ}^{2} + {( \frac{Δ β}{2} )}^{2} \qquad ( 8 )$$

where Δβ is the mismatch in propagation constant between the modes in two cores when they are isolated. The crosstalk (in dB) can be determined using the following equation (9):

$$X = 10 log ( \frac{{P}_{2}}{{P}_{1}} ) = 10 log ( \frac{L}{{L}_{c}} 〈 {( \frac{κ}{g} )}^{2} {sin}^{2} ( g Δ L ) 〉 ) \qquad ( 9 )$$

The crosstalk between the two cores grows linearly in the linear scale, but does not grow linearly in the dB scale. As used herein, crosstalk performance is reported for a 100 km length of optical fiber. However, crosstalk performance can also be represented with respect to alternative optical fiber lengths, with appropriate scaling. For optical fiber lengths other than 100 km, the crosstalk between cores can be determined using the following equation (10):

$$X ( L ) = X ( 100 ) + 10 log ( \frac{L}{100} ) \qquad ( 10 )$$

For example, for a 10 km length of optical fiber, the crosstalk can be determined by adding “−10 dB” to the crosstalk value for a 100 km length optical fiber. For a 1 km length of optical fiber, the crosstalk can be determined by adding “−20 dB” to the crosstalk value for a 100 km length of optical fiber.

Discussions regarding methods for determining crosstalk between cores in a multicore optical fiber can be found in M. Li, et al., “Coupled Mode Analysis of Crosstalk in Multicore Fiber with Random Perturbations,” in Optical Fiber Communication Conference, OSA Technical Digest (online), Optical Society of America, 2015, paper W2A.35, and Shoichiro Matsuo, et al., “Crosstalk behavior of cores in multi-core fiber under bent condition,” IEICE Electronics Express, Vol. 8, No. 6, p. 385-390, published Mar. 25, 2011 and Lukasz Szostkiewicz, et al., “Cross talk analysis in multicore optical fibers by supermode theory,” Optics Letters, Vol. 41, No. 16, p. 3759-3762, published Aug. 15, 2016, the contents of which are both incorporated herein by reference in their entirety.

According to one aspect, the cores Cᵢ of the multicore optical fiber 10 can be characterized by an attenuation of less than 0.18 dB/km at an operating wavelength of 1550 nm. For example, the attenuation can be less than 0.18 dB/km, less than 0.175 dB/km, less than 0.17 dB/km, or less than 0.16 dB/km at an operating wavelength of 1550 nm. Each core Cᵢ may have the same or different attenuation.

According to one aspect, the cores Cᵢ of the multicore optical fiber 10 can be characterized by an effective area (“A_{eff}”) of at least 50 μm² at 1550 nm. Each core Cᵢ may have the same or different effective area. In one aspect, the effective area is at least 50 μm², at least 75 μm², at least 100 μm², at least 125 μm², at least 150 μm², or at least 200 μm² at 1550 nm. For example, the effective area can be from about 50 μm² to about 200 μm², about 75 μm² to about 200 μm², about 100 μm² to about 200 μm², about 125 μm² to about 200 μm², about 150 μm² to about 200 μm², or about 175 μm² to about 200 μm² at 1550 nm. For example, the effective area can be about 50 μm², about 75 μm², about 100 μm², about 110 μm², about 112 μm², about 125 μm², about 150 μm², about 152 μm², about 175 μm², about 200 μm² or any effective area between these values.

According to one aspect, the cores Cᵢ of the multicore optical fiber 10 can be characterized by an effective area of at least 50 μm² at 1310 nm. Each core Cᵢ may have the same or different effective area. In one aspect, the effective area is at least 50 μm², at least 55 μm², at least 60 μm², at least 65 μm², at least 70 μm², or at least 75 μm² at 1310 nm. For example, the effective area can be from about 50 μm² to about 75 μm², about 55 μm² to about 75 μm², about 60 μm² to about 75 μm², about 65 μm² to about 75 μm², or about 60 μm² to about 75 μm² at 1310 nm. For example, the effective area can be about 50 μm², about 55 μm², about 60 μm², about 65 μm², about 66 μm², about 68 μm², about 69 μm², about 70 μm², about 72 μm², about 75 μm² or any effective area between these values.

According to one aspect, the mode field diameter of the cores Cᵢ is at least 6 μm, at least 8 μm, at least 10 μm, at least 12 μm, or at least 13 μm at 1550 nm. For example, the mode field diameter can be from about 6 μm to about 15 μm, about 8 μm to about 15 μm, about 10 μm to about 15 μm, about 6 μm to about 12 μm, about 8 μm to about 12 μm, about 10 μm to about 12 μm, about 6 μm to about 10 μm, or about 8 μm to about 10 μm at 1550 nm. For example, the mode field diameter can be about 6 μm, about 8 μm, about 9 μm, about 10 μm, about 11 μm, about 12 μm, about 13 μm, about 14 μm, about 15 μm, or any value between these values at 1550 nm.

According to one aspect, the mode field diameter of the cores Cᵢ is at least 5 μm, at least 9 μm, at least 10 μm, at least 12 μm, or at least 13 μm at 1310 nm. For example, the mode field diameter can be from about 5 μm to about 15 μm, about 9 μm to about 15 μm, or about 10 μm to about 15 μm at 1310 nm. For example, the mode field diameter can be about 5 μm, about 8 μm, about 9 μm, about 10 μm, about 11 μm, about 12 μm, about 13 μm, about 14 μm, about 15 μm, or any value between these values at 1310 nm. Each core Cᵢ may have the same or different mode field diameter at each operating wavelength of 1550 nm and 1310 nm.

According to an aspect of the present disclosure, the cores Cᵢ may have a theoretical cutoff wavelength of less than about 1500 nm, less than about 1400 nm, less than about 1300 nm, less than about 1260 nm, or less than about 1200 nm. For example, the theoretical cutoff wavelength can be from about 1300 nm to about 1500 nm or about 1300 nm to about 1400 nm. For example, the theoretical cutoff wavelength can be about 1300 nm, about 1310 nm, about 1320 nm, about 1329 nm, about 1330 nm, about 1340 nm, about 1350 nm, about 1360 nm, about 1370 nm, about 1380 nm, about 1400 nm, about 1500 nm, or any theoretical cutoff wavelength between these values. Each of the cores Cᵢ may have the same or different theoretical cutoff wavelength.

According to one aspect, a cable cutoff wavelength of the cores Cᵢ is less than about 1500 nm, less than about 1400 nm, less than about 1300 nm, less than about 1260 nm, or less than about 1200 nm. For example, the cable cutoff wavelength can be from about 1200 nm to about 1500 nm, about 1200 nm to about 1400 nm, about 1200 nm to about 1300 nm, about 1300 nm to about 1500 nm, about 1300 nm to about 1400 nm, or about 1400 nm to about 1500 nm. For example, the cable cutoff wavelength can be about 1200 nm, about 1209 nm, about 1210 nm, about 1220 nm, about 1230 nm, about 1240 nm, about 1250 nm, about 1260 nm, about 1300 nm, about 1310 nm, about 1350 nm, about 1400 nm, about 1410 nm, about 1420 nm, about 1430 nm, about 1440 nm, about 1450 nm, about 1460 nm, about 1500 nm, or any cable cutoff wavelength between these values. Each of the cores Cᵢ may have the same or different cable cutoff wavelength.

According to one aspect, the cores Cᵢ can have a zero dispersion wavelength of from about 1200 nm to about 1400 nm. For example, the zero dispersion wavelength can be about 1200 nm to about 1400 nm, about 1250 nm to about 1400 nm, about 1300 nm to about 1400 nm, about 1350 nm to about 1400 nm, about 1200 nm to about 1350 nm, about 1200 nm to about 1300 nm, about 1250 nm to about 1350 nm, about 1250 nm to about 1300 nm, or about 1300 nm to about 1324 nm. For example, the zero dispersion wavelength can be about 1200 nm, about 1210 nm, about 1225 nm, about 1250 nm, about 1275 nm, about 1278 nm, about 1280 nm, about 1285 nm, about 1289 nm, about 1290 nm, about 1300 nm, about 1301 nm, about 1305 nm, about 1306 nm, about 1310 nm, about 1325 nm, about 1350 nm, about 1375 nm, about 1400 nm, or any zero dispersion wavelength between these values. Each of the cores Cᵢ may have the same or different zero dispersion wavelength.

According to an aspect of the present disclosure, the cores Cᵢ can have a dispersion having an absolute value at 1310 nm of less than 3 ps/nm/km and a dispersion slope at 1310 nm of less than 0.1 ps/nm²/km. Each of the cores Cᵢ may have the same or different dispersion and dispersion slope at 1310 nm. For example, the absolute value of the dispersion at 1310 nm can be from about 0.3 ps/nm/km to about 3 ps/nm/km, about 0.3 ps/nm/km to about 2.75 ps/nm/km, about 0.3 ps/nm/km to about 2.5 ps/nm/km, about 0.3 ps/nm/km to about 2.25 ps/nm/km, about 0.3 ps/nm/km to about 2 ps/nm/km, about 0.3 ps/nm/km to about 1.75 ps/nm/km, about 0.3 ps/nm/km to about 1.5 ps/nm/km, or about 0.3 ps/nm/km to about 1 ps/nm/km. For example, the absolute value of the dispersion at 1310 can be about 0.3 ps/nm/km, about 0.35 ps/nm/km, about 0.4 ps/nm/km, about 0.5 ps/nm/km, about 0.75 ps/nm/km, about 1 ps/nm/km, about 1.25 ps/nm/km, about 1.5 ps/nm/km, about 1.75 ps/nm/km, about 2 ps/nm/km, about 2.25 ps/nm/km, about 2.5 ps/nm/km, about 2.75 ps/nm/km, about 3 ps/nm/km, or any value between these values. In one example, the dispersion slope at 1310 nm can be about 0.075 ps/nm²/km to about 0.1 ps/nm²/km, about 0.08 ps/nm²/km to about 0.1 ps/nm²/km, about 0.085 ps/nm²/km to about 0.1 ps/nm²/km, about 0.09 ps/nm²/km to about 0.1 ps/nm²/km, about 0.075 ps/nm²/km to about 0.09 ps/nm²/km, about 0.08 ps/nm²/km to about 0.09 ps/nm²/km, or about 0.085 ps/nm²/km to about 0.09 ps/nm²/km. For example, the dispersion slope at 1310 nm can be about 0.075 ps/nm²/km, about 0.08 ps/nm²/km, about 0.085 ps/nm²/km, about 0.086 ps/nm²/km, about 0.087 ps/nm²/km, about 0.088 ps/nm²/km, about 0.089 ps/nm²/km, about 0.09 ps/nm²/km, about 0.01 ps/nm²/km, or any value between these values.

According to an aspect of the present disclosure, the cores Cᵢ can have a dispersion at 1550 nm of less than 22 ps/nm/km and a dispersion slope at 1550 nm of less than 0.1 ps/nm²/km. Each of the cores Cᵢ may have the same or different dispersion and dispersion slope at 1550 nm. For example, the dispersion at 1550 nm can be from about 10 ps/nm/km to about 22 ps/nm/km, about 10 ps/nm/km to about 22 ps/nm/km, about 10 ps/nm/km to about 20 ps/nm/km, about 10 ps/nm/km to about 15 ps/nm/km, about 15 ps/nm/km to about 22 ps/nm/km, or about 15 ps/nm/km to about 20 ps/nm/km. For example, the dispersion at 1550 can be about 10 ps/nm/km, about 15 ps/nm/km, about 16 ps/nm/km, about 17 ps/nm/km, about 17.5 ps/nm/km, about 18 ps/nm/km, about 19 ps/nm/km, about 19.5 ps/nm/km, about 19.6 ps/nm/km, about 20 ps/nm/km, about 20.1 ps/nm/km, about 22 ps/nm/km, or any value between these values. In one example, the dispersion slope at 1550 nm can be about 0.04 ps/nm²/km to about 0.1 ps/nm²/km, about 0.05 ps/nm²/km to about 0.1 ps/nm²/km, about 0.055 ps/nm²/km to about 0.1 ps/nm²/km, about 0.06 ps/nm²/km to about 0.1 ps/nm²/km, about 0.08 ps/nm²/km to about 0.1 ps/nm²/km, about 0.04 ps/nm²/km to about 0.08 ps/nm²/km, about 0.05 ps/nm²/km to about 0.08 ps/nm²/km, about 0.055 ps/nm²/km to about 0.08 ps/nm²/km, about 0.06 ps/nm²/km to about 0.08 ps/nm²/km, about 0.04 ps/nm²/km to about 0.06 ps/nm²/km, about 0.05 ps/nm²/km to about 0.06 ps/nm²/km, or about 0.055 ps/nm²/km to about 0.06 ps/nm²/km. For example, the dispersion slope at 1550 nm can be about 0.04 ps/nm²/km, about 0.05 ps/nm²/km, about 0.055 ps/nm²/km, about 0.057 ps/nm²/km, about 0.058 ps/nm²/km, about 0.059 ps/nm²/km, about 0.06 ps/nm²/km, about 0.061 ps/nm²/km, about 0.07 ps/nm²/km, about 0.08 ps/nm²/km, or any value between these values.

According to one aspect, the bending loss of the multicore optical fiber 10 at 1550 nm as determined by the mandrel wrap test using a mandrel having a diameter of 10 mm may be less than about 3 dB/turn, less than about 2.5 dB/turn, less than about 2 dB/turn, less than about 1.5 dB/turn, or less than about 1 dB/turn. For example, the bend loss can be from about 0.5 dB/turn to about 3 dB/turn, about 0.5 dB/turn to about 2.5 dB/turn, about 0.5 dB/turn to about 2 dB/turn, about 0.5 dB/turn to about 1.5 dB/turn, about 0.5 dB/turn to about 1 dB/turn, about 1 dB/turn to about 3 dB/turn, about 1 dB/turn to about 2.5 dB/turn, about 1 dB/turn to about 2 dB/turn, about 1 dB/turn to about 1.5 dB/turn, about 1.5 dB/turn to about 3 dB/turn, about 1.5 dB/turn to about 2.5 dB/turn, about 1.5 dB/turn to about 2 dB/turn, about 2 dB/turn to about 3 dB/turn, or about 2 dB/turn to about 2.5 dB/turn using a mandrel having a diameter of 10 mm. For example, the bend loss can be about 0.5 dB/turn, about 0.75 dB/turn, about 0.9 dB/turn, about 1 dB/turn, about 1.5 dB/turn, about 2 dB/turn, about 2.5 dB/turn, about 3 dB/turn, or any value between these values, using a mandrel having a diameter of 10 mm.

According to one aspect, the bending loss of the multicore optical fiber 10 at 1550 nm as determined by the mandrel wrap test using a mandrel having a diameter of 15 mm may be less than about 1 dB/turn, less than about 0.5 dB/turn, or less than about 0.3 dB/turn. For example, the bend loss can be from about 0.1 dB/turn to about 1 dB/turn, about 0.1 dB/turn to about 0.75 dB/turn, about 0.1 dB/turn to about 0.5 dB/turn, about 0.2 dB/turn to about 1 dB/turn, about 0.2 dB/turn to about 0.75 dB/turn, about 0.2 dB/turn to about 0.5 dB/turn, about 0.3 dB/turn to about 1 dB/turn, about 0.3 dB/turn to about 0.75 dB/turn, or about 0.3 dB/turn to about 0.5 dB/turn, using a mandrel having a diameter of 15 mm. For example, the bend loss can be about 0.2 dB/turn, about 0.23 dB/turn, about 0.25 dB/turn, about 0.3 dB/turn, about 0.5 dB/turn, about 0.6 dB/turn, about 0.75 dB/turn, about 1 dB/turn, or any value between these values, using a mandrel having a diameter of 15 mm.

According to one aspect, the bending loss of the multicore optical fiber 10 at 1550 nm as determined by the mandrel wrap test using a mandrel having a diameter of 20 mm may be less than about 3 dB/turn, less than about 2 dB/turn, less than about 1 dB/turn, less than about 0.5 dB/turn, or less than about 0.3 dB/turn. For example, the bend loss can be from about 0.1 dB/turn to about 3 dB/turn, about 0.1 dB/turn to about 2.5 dB/turn, about 0.1 dB/turn to about 2 dB/turn, about 0.2 dB/turn to about 3 dB/turn, about 0.2 dB/turn to about 2.5 dB/turn, about 0.2 dB/turn to about 2 dB/turn, about 0.3 dB/turn to about 3 dB/turn, about 0.3 dB/turn to about 2.5 dB/turn, or about 0.3 dB/turn to about 2 dB/turn, about 0.1 dB/turn to about 1 dB/turn, about 0.1 dB/turn to about 0.75 dB/turn, about 0.1 dB/turn to about 0.5 dB/turn, 0.5 dB/turn to about 3 dB/turn, about 0.5 dB/turn to about 2.5 dB/turn, about 0.5 dB/turn to about 2 dB/turn, 1 dB/turn to about 3 dB/turn, about 1 dB/turn to about 2.5 dB/turn, or about 1 dB/turn to about 2 dB/turn, using a mandrel having a diameter of 20 mm. For example, the bend loss can be about 0.2 dB/turn, about 0.23 dB/turn, about 0.25 dB/turn, about 0.3 dB/turn, about 0.5 dB/turn, about 0.6 dB/turn, about 0.75 dB/turn, about 0.8 dB/turn, about 0.9 dB/turn, about 1 dB/turn, about 2 dB/turn, about 2.1 dB/turn, about 2.5 dB/turn, about 3 dB/turn, or any value between these values, using a mandrel having a diameter of 20 mm.

According to one aspect, the bending loss of the multicore optical fiber 10 at 1550 nm as determined by the mandrel wrap test using a mandrel having a diameter of 30 mm may be less than about 1 dB/turn, less than about 0.5 dB/turn, less than about 0.25 dB/turn, or less than about 0.1 dB/turn. For example, the bend loss can be from about 0.01 dB/turn to about 1 dB/turn, about 0.01 dB/turn to about 0.5 dB/turn, about 0.01 dB/turn to about 0.25 dB/turn, about 0.01 dB/turn to about 0.2 dB/turn, about 0.01 dB/turn to about 0.1 dB/turn, about 0.01 dB/turn to about 0.05 dB/turn, about 0.05 dB/turn to about 1 dB/turn, about 0.05 dB/turn to about 0.5 dB/turn, about 0.05 dB/turn to about 0.25 dB/turn, or about 0.05 dB/turn to about 0.2 dB/turn, about 0.2 dB/turn to about 1 dB/turn, about 0.2 dB/turn to about 0.5 dB/turn, or about 0.5 dB/turn to about 1 dB/turn, using a mandrel having a diameter of 30 mm. For example, the bend loss can be about 0.01 dB/turn, about 0.05 dB/turn, about 0.06 dB/turn, about 0.07 dB/turn, about 0.08 dB/turn, about 0.09 dB/turn, about 0.1 dB/turn, about 0.12 dB/turn, about 0.13 dB/turn, about 0.15 dB/turn, about 0.2 dB/turn, about 0.23 dB/turn, about 0.24 dB/turn, about 0.24 dB/turn, about 0.25 dB/turn, about 0.3 dB/turn, about 0.31 dB/turn, about 0.4 dB/turn, about 0.5 dB/turn, about 0.51 dB/turn, about 1 dB/turn, or any value between these values using a mandrel having a diameter of 30 mm.

According to one aspect, the bending loss of the multicore optical fiber 10 at 1550 nm as determined by the mandrel wrap test using a mandrel having a diameter of 40 mm may be less than about 0.3 dB/turn, less than about 0.2 dB/turn, or less than about 0.1 dB/turn. For example, the bend loss can be from about 0.01 dB/turn to about 0.3 dB/turn, about 0.05 dB/turn to about 0.3 dB/turn, about 0.1 dB/turn to about 0.3 dB/turn, about 0.01 dB/turn to about 0.2 dB/turn, about 0.05 dB/turn to about 0.2 dB/turn, about 0.1 dB/turn to about 0.2 dB/turn, about 0.01 dB/turn to about 0.1 dB/turn, or about 0.05 dB/turn to about 0.1 dB/turn, using a mandrel having a diameter of 40 mm. For example, the bend loss can be about 0.01 dB/turn, about 0.02 dB/turn, about 0.03 dB/turn, about 0.04 dB/turn, about 0.05 dB/turn, about 0.06 dB/turn, about 0.07 dB/turn, about 0.08 dB/turn, about 0.09 dB/turn, about 0.1 dB/turn, about 0.11 dB/turn, about 0.12 dB/turn, about 0.13 dB/turn, about 0.2 dB/turn, about 0.3 dB/turn, or any value between these values, using a mandrel having a diameter of 40 mm.

According to one aspect, the bending loss of the multicore optical fiber 10 at 1550 nm as determined by the mandrel wrap test using a mandrel having a diameter of 50 mm may be less than about 0.05 dB/turn, less than about 0.04 dB/turn, or less than about 0.03 dB/turn. For example, the bend loss can be from about 0.005 dB/turn to about 0.05 dB/turn, about 0.005 dB/turn to about 0.03 dB/turn, about 0.005 dB/turn to about 0.02 dB/turn, or about 0.01 dB/turn to about 0.05 dB/turn, using a mandrel having a diameter of 50 mm. For example, the bend loss can be about 0.01 dB/turn, about 0.02 dB/turn, about 0.03 dB/turn, about 0.032 dB/turn, about 0.039 dB/turn, about 0.04 dB/turn, about 0.05 dB/turn, or any value between these values, using a mandrel having a diameter of 50 mm.

According to one aspect, the bending loss of the multicore optical fiber 10 at 1550 nm as determined by the mandrel wrap test using a mandrel having a diameter of 60 mm may be less than about 0.05 dB/turn, less than about 0.03 dB/turn, or less than about 0.02 dB/turn. For example, the bend loss can be from about 0.001 dB/turn to about 0.05 dB/turn, about 0.001 dB/turn to about 0.03 dB/turn, or about 0.001 dB/turn to about 0.02 dB/turn, using a mandrel having a diameter of 60 mm. For example, the bend loss can be about 0.001 dB/turn, about 0.002 dB/turn, about 0.0023 dB/turn, about 0.005 dB/turn, about 0.006 dB/turn, about 0.007 dB/turn, about 0.008 dB/turn, about 0.009 dB/turn, about 0.01 dB/turn, about 0.016 dB/turn, about 0.02 dB/turn, about 0.03 dB/turn, about 0.05 dB/turn, or any value between these values using a mandrel having a diameter of 60 mm.

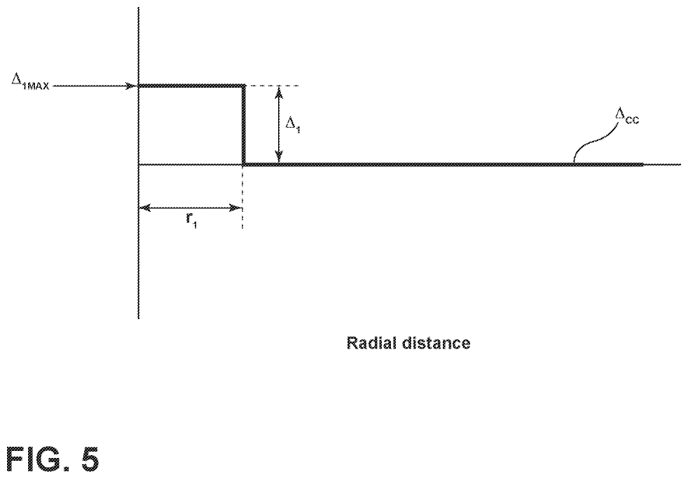

Exemplary configurations of the multicore optical fiber 10, Exemplary MCF A-D, according to aspects of the present disclosure are shown in Table 1 below and FIGS. 5-11. Table 1 identifies the combination of materials according to the present disclosure. The core Cᵢ, inner cladding ICᵢ, and/or common cladding 20 can include additional components according to aspects of the present disclosure discussed herein. While the exemplary configurations Exemplary MCF A-D are discussed and illustrated in FIGS. 5-11 in the context of a first core C₁ and optional first inner cladding IC₁, it is understood that the multicore optical fiber 10 can include any combination of any one or more cores and inner claddings corresponding to Exemplary MCF A-D.

TABLE 1
Exemplary Multicore Optical Fiber Configurations.

| Exemplary MCF | Core | Inner Cladding | Common cladding |
|---|---|---|---|
| Exemplary MCF | silica glass doped | N/A | undoped silica |
| A | with >3 wt % Cl | | glass |
| Exemplary MCF | silica glass doped | undoped silica | silica glass doped |
| B | with >3 wt % Cl | glass | with Cl |
| Exemplary MCF | silica glass doped | silica glass | undoped silica |
| C | with >3 wt % Cl | doped with F | glass |
| Exemplary MCF | silica glass doped | silica glass | silica glass doped |
| D | with >3 wt % Cl | doped with F | with F |
| Exemplary MCF | silica glass doped | silica glass | silica glass doped |
| D | with >3 wt % Cl | doped with F | with Cl |

FIG. 5 is a schematic refractive index profile corresponding to an example multicore optical fiber 10 corresponding to Exemplary MCF A. The core C₁ can have an outer radius r₁ and a maximum relative refractive index Δ_{1MAX} that is greater than the relative refractive index Δ_{CC} of the undoped silica glass common cladding. The core C₁ of Exemplary MCF A has a step-index core profile.

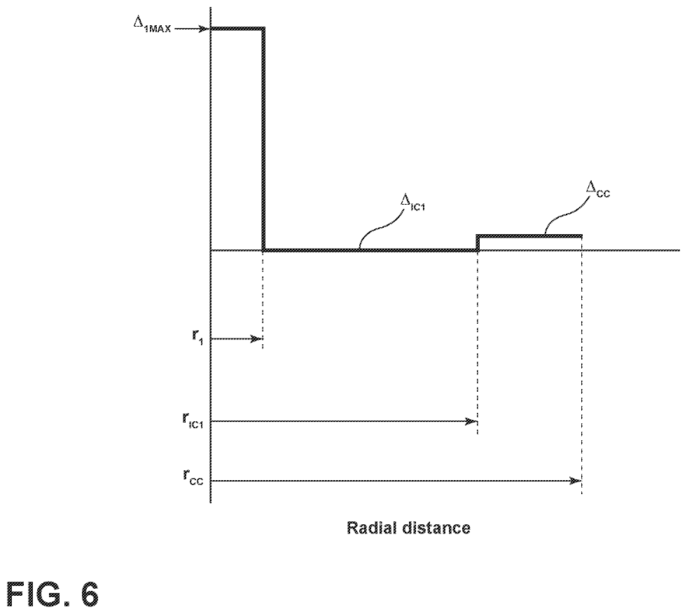

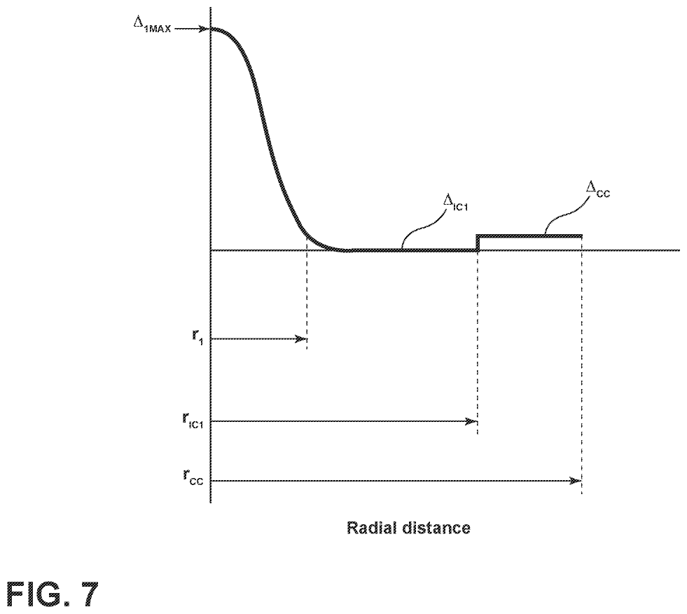

FIGS. 6-7 illustrate schematic refractive index profiles corresponding to example multicore optical fibers 10 corresponding to Exemplary MCF B. FIG. 6 illustrates the core C₁ having an outer radius r₁, a maximum relative refractive index Δ_{1MAX}, and a step-index core profile. The inner cladding IC₁ is undoped silica glass having an outer radius r_{IC1} and a relative refractive index Δ_{IC1}, wherein Δ_{1MAX}>Δ_{IC1}. The common cladding 20 is silica glass doped with chlorine and has an outer radius R_{CC} and a relative refractive index Δ_{CC}, wherein Δ_{1MAX}>Δ_{CC} and Δ_{IC1}<Δ_{CC}. FIG. 7 illustrates an example that is similar to the example illustrated by FIG. 6, except that the core C₁ has a graded-index core profile. It is understood that any of the cores Cᵢ described herein may have a step-index core profile, as illustrated in FIG. 6, or a graded-index core profile, as illustrated in FIG. 7. It is further understood that some cores of a multicore optical fiber may have a step-index core profile and other cores of the multicore optical fiber may have a graded-index core profile.

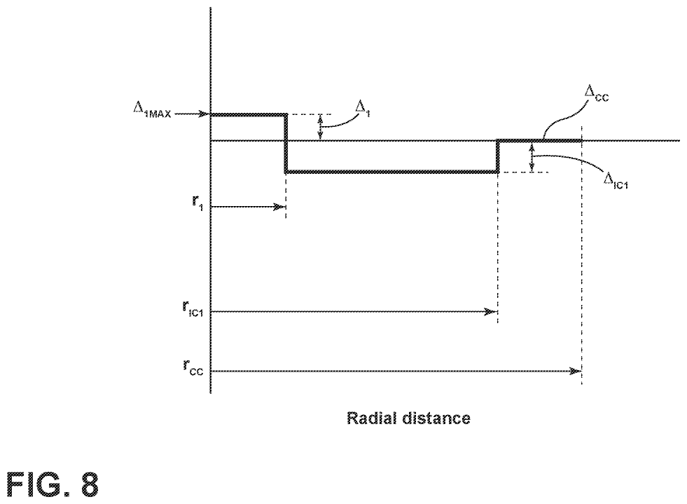

FIG. 8 illustrates a schematic refractive index profile corresponding to an example multicore optical fiber 10 corresponding to Exemplary MCF C. FIG. 8 illustrates the core C₁ having an outer radius r₁, a maximum relative refractive index Δ_{1MAX}, and a step-index core profile. The inner cladding IC₁ is silica glass doped with fluorine having an outer radius no and a relative refractive index Δ_{IC1}, wherein Δ_{1MAX}>Δ_{IC1} and Δ_{IC1}<0. The common cladding 20 is undoped silica glass and has an outer radius R_{CC} and a relative refractive index Δcc, wherein Δ_{1MAX}>Δ_{CC} and Δ_{IC1}<Δ_{CC}. In another embodiment, the core of Exemplary MCF C has a graded-index core profile.

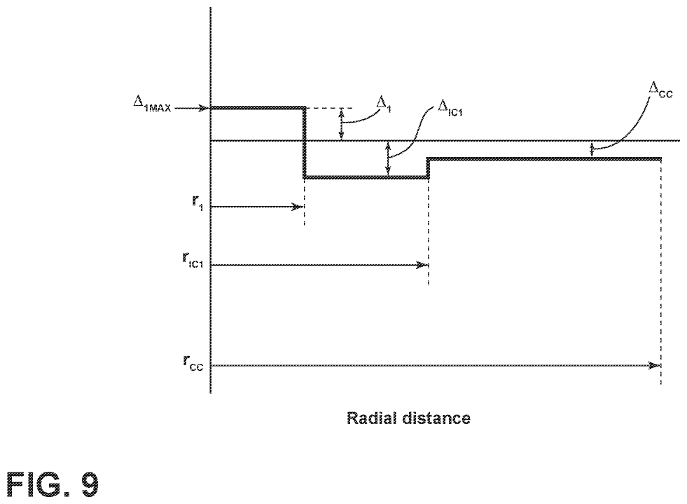

FIG. 9 illustrates a schematic refractive index profile corresponding to an example multicore optical fiber 10 corresponding to Exemplary MCF D. FIG. 9 illustrates the core C₁ having an outer radius r₁, a maximum relative refractive index Δ_{1MAX}, and a step-index core profile. The inner cladding IC₁ is silica glass doped with fluorine having an outer radius no and a relative refractive index Δ_{IC1}, wherein Δ_{1MAX}>Δ_{IC1} and Δ_{IC1}<0. The common cladding 20 is silica glass doped with fluorine and has an outer radius R_{CC} and a relative refractive index Δ_{CC}, wherein Δ_{1MAX}>Δ_{CC} and Δ_{IC1}<Δ_{CC} and both Δ_{IC1} and Δ_{CC}<0. In another embodiment, the core of Exemplary MCF D has a graded-index core profile.

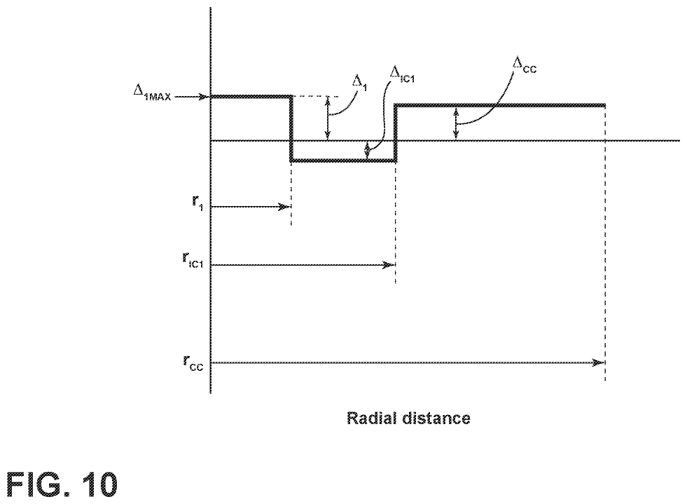

FIG. 10 illustrates a schematic refractive index profile corresponding to an example multicore optical fiber 10 corresponding to Exemplary MCF E. FIG. 10 illustrates the core C₁ having an outer radius r₁, a maximum relative refractive index Δ_{1MAX}, and a step core profile. The inner cladding IC₁ is silica glass doped with fluorine having an outer radius no_ and a relative refractive index Δ_{IC1}, wherein Δ_{1MAX}>Δ_{IC1} and Δ_{IC1}<0. The common cladding 20 is silica glass doped with chlorine and has an outer radius R_{CC} and a relative refractive index Δ_{CC}, wherein Δ_{1MAX}>Δ_{CC}, Δ_{IC1}<Δ_{CC}, and Δ_{CC}>0. In another embodiment, the core of Exemplary MCF E has a graded-index core profile.

The multicore optical fibers 10 of the present disclosure can be made using any suitable method for forming a multicore optical fiber. See, for example, U.S. Pat. No. 9,120,693 and U.S. Published Patent Application No. 20150284286, the disclosures of which are incorporated herein by reference in their entirety. For example, the multicore optical fiber 10 can be formed by drawing a multicore preform made using conventional optical-fiber techniques, such as glass drilling or stacking. The glass drilling method can be used to form a multicore preform by drilling holes in a silica glass cylinder (pure, undoped silica or doped silica). The locations and dimensions of the holes are based on the multicore optical fiber design. Core canes having the desired refractive index profile and a diameter that is slightly smaller than the pre-drilled holes are then inserted into the pre-drilled holes to form the multicore preform. The multicore preform is then heated to a temperature sufficient to melt the silica glass forming the pre-drilled holes such that the pre-drilled holes collapse around the core canes. The multicore preform is then drawn into a fiber. The core canes can be made using any suitable conventional preform manufacturing technique, such as outside vapor deposition (OVD), modified chemical vapor deposition (MCVD), or plasma activated chemical vapor deposition (PCVD).

Suitable precursors for silica include SiCl₄ and organosilicon compounds. Organosilicon compounds are silicon compounds that include carbon, and optionally oxygen and/or hydrogen. Examples of suitable organosilicon compounds include octamethylcyclotetrasiloxane (OMCTS), silicon alkoxides (Si(OR)₄), organosilanes (SiR₄), and Si(OR)ₓR₄₋ₓ, where R is a carbon-containing organic group or hydrogen and where R may be the same or different at each occurrence, and wherein at least one R is a carbon-containing organic group. Suitable precursors for chlorine doping include Cl₂, SiCl₄, Si₂Cl₆, Si₂OCl₆, SiCl₃H, and CCl₄. Suitable precursors for fluorine doping include F₂, CF₄, and SiF₄. Regions of constant refractive index may be formed by not doping or by doping at a uniform concentration over the thickness of the region. Regions of variable refractive index are formed through non-uniform spatial distributions of dopants over the thickness of a region and/or through incorporation of different dopants in different regions. The OVD, MCVD, PCVD and other techniques for generating silica soot permit fine control of dopant concentration through layer-by-layer deposition with variable flow rate delivery of dopant precursors.

One exemplary method that can be used to form the multicore optical fibers of the present disclosure is a method that utilizes a cane-based optical fiber preform and then draws the optical fiber from the cane-based glass preform. An exemplary cane-based glass preform method is disclosed in Applicant's co-pending U.S. Patent Application Ser. No. 62/811,842, entitled “Vacuum-Based Methods of Forming a Cane-Based Optical Fiber Preform and Methods of Forming an Optical Fiber Using Same,” which was filed on Feb. 28, 2019, the contents of which are incorporated herein by reference in their entirety.

Briefly, a cane-based glass preform method for forming the multicore optical fibers 10 can include utilizing one or more glass cladding sections each having one or more precision axial holes formed therein and a top end with a recess defined by a perimeter lip. When using multiple glass cladding sections, the sections can be stacked so that the axial holes are aligned. A core cane can then be added to each axial hole to define a cane-cladding assembly. Top and bottom caps, respectively, can be added to the top and bottom of the cane-cladding assembly to define a preform assembly. The top cap closes off the recess at the top of the glass-cladding section. The bottom cap can have its own raised lip and recess that becomes closed off when the bottom cap is interfaced with the bottom end of the cane-cladding assembly. The closed-off recesses and gaps formed by the canes within the axial holes define a substantially sealed internal chamber. The preform assembly can then be dried and purified by drawing a select cleaning gas (e.g., chlorine) through a small passage in the bottom cap that leads to the internal chamber. A vacuum can be applied through the top cap to create a pressure differential between the internal chamber and the ambient environment. The pressure differential facilitates maintaining the components of the preform assembly together, and can be referred to as a vacuum-held preform assembly. The vacuum-held preform assembly can then be consolidated by heating in a furnace to just above the glass softening temperature so that the glass cladding section(s), the core canes, and the top and bottom caps, which are all made of glass, seal to one another. In addition, the glass flow can remove the internal chamber. The result is a solid glass preform that is ready to be drawn, especially if the furnace used for the consolidation is a draw furnace used for drawing optical fiber.

### EXAMPLES

The following examples describe various features and advantages provided by the disclosure, and are in no way intended to limit the invention and appended claims.

### Example 1

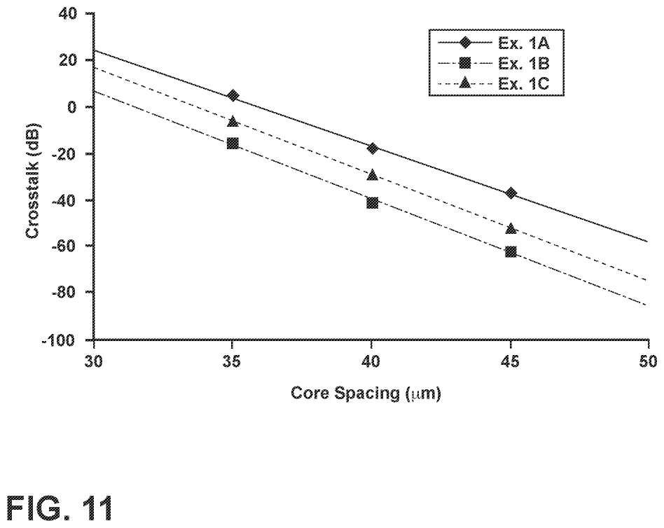

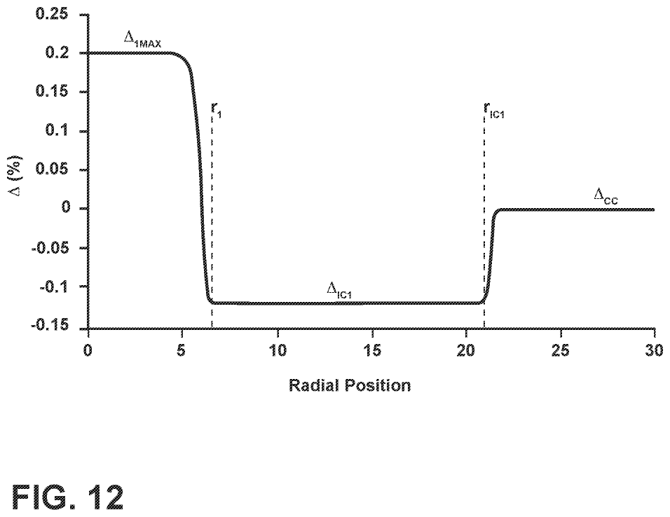

Referring to FIG. 11, the crosstalk for three different multicore optical fibers according to aspects of the present disclosure, Examples 1A, 1B, and 1C (“Ex. 1A,” “Ex. 1B,” and “Ex. 1C”), were mathematically modeled. Examples 1A-1C were multicore optical fibers having a circular cross-section, a fiber length of 100 km, and two cores, each core including silica doped with greater than 3.5 wt % chlorine. Table 2 below provides the details and optical properties for Ex. 1A-1C. In Example 1A, both cores had a step-index profile and an effective area of 80 μm². In Example 1B, both cores had a step-index profile, an inner cladding directly adjacent and surrounding the core, and an effective area of 80 μm². The inner cladding for Example 1B included silica doped with fluorine. Ex. 1A is represented schematically in the refractive index profile of FIG. 5 and Ex. 1B is represented schematically in the refractive index profile of FIG. 12. Example 1C was similar to Example 1B, except that each core of Example 1C included an effective area of 100 μm². Ex. 1C is represented schematically in the refractive index profile of FIG. 8. The data in FIG. 11 demonstrates the ability of the cores of the present disclosure to be configured to provide low crosstalk, in most cases below 0 dB for a core spacing of 35 μm or more. The effective area, inner cladding, and/or core spacing can be configured to provide a desired level of crosstalk.

The distance between cores for Ex. 1A-1C was measured as described above using a Cartesian coordinate system to determine the (x, y) position of the centerline of each core and then determining the distance between the core centerlines.

TABLE 2
Features and Optical Properties of Examples 1A-1C.

| Parameter | Ex. 1A | Ex. 1B | Ex. 1C |
|---|---|---|---|
| Δ₁, Δ₂ (%) | 0.34 | 0.2 | 0.34 |
| Cl in core (wt. %) | 5.40 | 3.17 | 5.40 |
| r₁, r₂ (μm) | 4.2 | 6.2 | 4.9 |
| Δ_{IC1}, Δ_{IC2} (%) | — | −0.12 | −0.07 |
| inner cladding dopant | — | F | F |
| F in inner cladding (wt %) | — | 0.4 | 0.23 |
| r_{IC1}, r_{IC2} (μm) | — | 22 | 14.8 |
| δr_{IC1}, δr_{IC2} (μm) | — | 15.8 | 9.9 |
| R_{CC} | 62.5 | 62.5 | 62.5 |
| Δ_{CC} (%) | 0 | 0 | 0 |
| Common cladding dopant | — | — | — |

### Example 2

Table 3 below provides the details and optical properties for modeled exemplary multicore optical fibers, Examples 2A-2D (“Ex. 2A,” “Ex. 2B,” “Ex. 2C,” and “Ex. 2D”). All four examples, Ex. 2A-2D, had a core consisting of Cl-doped silica with a core alpha value of 100 and an attenuation at 1550 nm of <0.17 dB/km. When core alpha has a value of 100, the relative refractive index Δ₁ of the core is approximately constant and the relative refractive index profile of the core closely approximates a step-index profile. Ex. 2A and Ex. 2B lack an inner cladding and have a common cladding of undoped silica directly adjacent to the core (as shown schematically in FIG. 5). Ex. 2C has an inner cladding of down-doped silica directly adjacent to the core and a common cladding of undoped silica directly adjacent to the inner cladding (as shown schematically in FIG. 8). Ex. 2D has an inner cladding of undoped silica directly adjacent to the core and an common cladding of up-doped silica directly adjacent the inner cladding (as shown schematically in FIG. 6). Each of Ex. 2A-2D included two cores configured identically as indicated in Table 3 with a spacing between adjacent cores (measured between centerlines of adjacent cores) of 55 μm and a core to fiber edge distance of 35 μm. The two cores were disposed symmetrically about the centerline of the multicore optical fiber (as shown schematically in FIG. 2). The centerline-to-centerline spacing of the cores can be based at least in part on the desired crosstalk of the optical fiber and the number of cores accommodated by the optical fiber. In some embodiments, the centerline-to-centerline spacing of the cores is greater than about 28 μm, greater than about 30 μm, or greater than about 40 μm.

TABLE 3
Features and Optical Properties of Examples 2A-2D.

| Parameter | Ex. 2A | Ex. 2B | Ex. 2C | Ex. 2D |
|---|---|---|---|---|
| Δ₁, Δ₂ (%) | 0.34 | 0.34 | 0.34 | 0.347 |
| Cl in core (wt. %) | 5.40 | 5.40 | 5.40 | 5.51 |
| r₁, r₂ (nm) | 4.2 | 4.45 | 4.9 | 5.1 |
| Δ_{IC1}, Δ_{IC2} (%) | — | — | −0.07 | — |
| inner cladding dopant | — | — | F | — |
| F in inner cladding (wt %) | — | — | 0.23 | — |
| r_{IC1}, r_{IC2} (μm) | — | — | 14.8 | 15.4 |
| δr_{IC1}, δr_{IC2} (μm) | — | — | 9.9 | 10.3 |
| R_{CC} (μm) | 62.5 | 62.5 | 62.5 | 62.5 |
| Δ_{CC} (%) | 0 | 0 | 0 | 0.07 |
| Common cladding dopant | — | — | — | Cl |
| Theoretical Cutoff | 1330 | 1370 | 1329 | 1329 |
| wavelength (nm) | | | | |
| Cable cutoff wavelength | 1210 | 1250 | 1209 | 1209 |
| (nm) | | | | |
| Zero-dispersion | 1306 | 1301 | 1289 | 1278 |
| wavelength (nm) | | | | |
| Mode field diameter at | 9.1 | 9.2 | 9.1 | 9.3 |
| 1310 nm (μm) | | | | |
| Effective area at 1310 nm | 66.2 | 68 | 68.6 | 72 |
| (μm²) | | | | |
| Dispersion at 1310 nm | 0.35 | 0.75 | 2.55 | 2.87 |
| (ps/nm/km) | | | | |
| Dispersion Slope at 1310 | 0.086 | 0.0866 | 0.0881 | 0.0888 |
| nm (ps/nm²/km) | | | | |
| Mode field diameter at | 10.3 | 10.4 | 10 | 10.2 |
| 1550 nm (μm) | | | | |
| Effective area at 1550 nm | 80.2 | 83.6 | 80.1 | 83.3 |
| (μm²) | | | | |
| Dispersion at 1550 nm | 17 | 17.5 | 19.6 | 20.1 |
| (ps/nm/km) | | | | |
| Dispersion Slope at 1550 | 0.0576 | 0.0579 | 0.0587 | 0.0593 |
| nm (ps/nm²/km) | | | | |

### Example 3

Table 4 below provides the details and optical properties for modeled exemplary multicore optical fibers, Examples 3A-3C (“Ex. 3A,” “Ex. 3B,” and “Ex. 3C”). All three examples, Ex. 3A-3C, had an attenuation at 1550 nm of <0.17 dB/km. All of the bend loss values listed in Table 4 are for optical fibers operating at 1550 nm. Ex. 3A-3C included two cores configured as indicated in Table 4 with a spacing between adjacent cores (measured between centerlines of adjacent cores) of 55 μm and a core to fiber edge distance of 35 μm. The centerline-to-centerline spacing of the cores can be based at least in part on the desired crosstalk of the optical fiber and the number of cores accommodated by the optical fiber. In some embodiments, the centerline-to-centerline spacing of the cores is greater than about 28 μm, greater than about 30 μm, or greater than about 40 μm. The two cores were disposed symmetrically about the centerline of the multicore optical fiber (as shown schematically in FIG. 2).

TABLE 4
Features and Optical Properties of Examples 3A-3C.

| Parameter | Ex. 3A | Ex. 3B | Ex. 3C |
|---|---|---|---|
| Δ₁, Δ₂ (%) | 0.2 | 0.2 | 0.25 |
| Cl in core (wt%) | 3.17 | 3.17 | 3.17 |
| r₁, r₂ (μm) | 6.2 | 7.3 | 7.4 |
| Δ_{IC1}, Δ_{IC2} (%) | −0.12 | −0.05 | 0 |
| inner cladding dopant | F | F | none |
| F in inner cladding (wt %) | 0.4 | 0.17 | 0 |
| r_{IC1}, r_{IC2} (μm) | 22 | 25 | 25 |
| δr_{IC1}, Δr_{IC2} (μm) | 15.8 | 17.7 | 17.6 |
| Trench volume (% Δμm2) | 107 | 57 | 62 |
| Δ_{CC} (%) | 0 | 0.02 | 0.055 |
| R_{CC} (μm) | 62.5 | 62.5 | 62.5 |
| Mode field diameter at 1550 nm (μm) | 11.785 | 13.571 | 13.65 |
| Effective area at 1550 nm (μm²) | 112.338 | 150.14 | 152.34 |
| Dispersion at 1550 nm (ps/nm/km) | 20.947 | 21.3 | 21.27 |
| Dispersion Slope at 1550 nm | 0.0609 | 0.061 | 0.061 |
| (ps/nm²/km) | | | |
| 22-meter cable cutoff wavelength (nm) | 1400 | 1430 | 1450 |
| 20 mm bend loss (dB/turn) | 0.9332 | 2.0855 | 2.0497 |
| 30 mm bend loss (dB/turn) | 0.2382 | 0.5117 | 0.3109 |
| 40 mm bend loss (dB/turn) | 0.0968 | 0.1287 | 0.0603 |
| 50 mm bend loss (dB/turn) | 0.0394 | 0.0324 | 0.0117 |
| 60 mm bend loss (dB/turn) | 0.0160 | 0.0081 | 0.0023 |

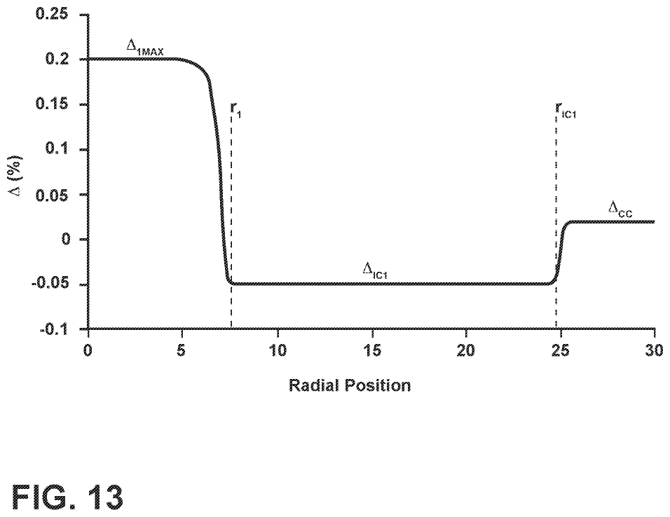

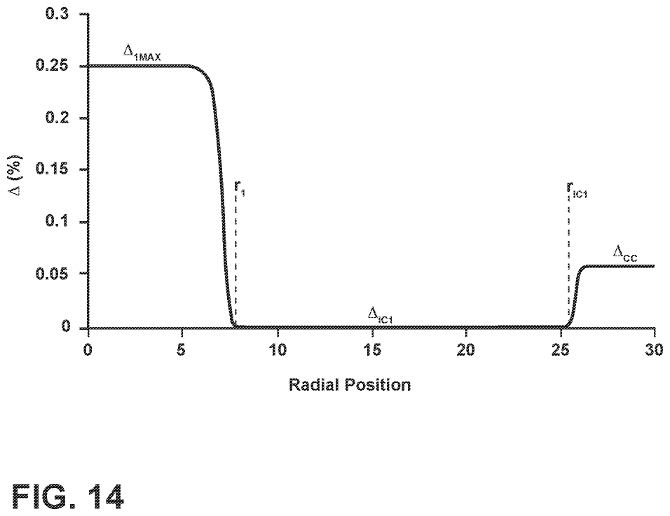

Each core of each of Ex. 3A, Ex. 3B, and Ex. 3C included an inner cladding directly adjacent to the core and a common cladding directly adjacent to the inner cladding. Ex. 3A is illustrated schematically in the refractive index profile of FIG. 12, Ex. 3B is illustrated schematically in the refractive index profile of FIG. 13, and Ex. 3C is illustrated schematically in the refractive index profile of FIG. 14. As illustrated in FIGS. 12-14, the cores of Ex. 3A, 3B, and 3C, respectively, had a graded-index profile.

### Example 4

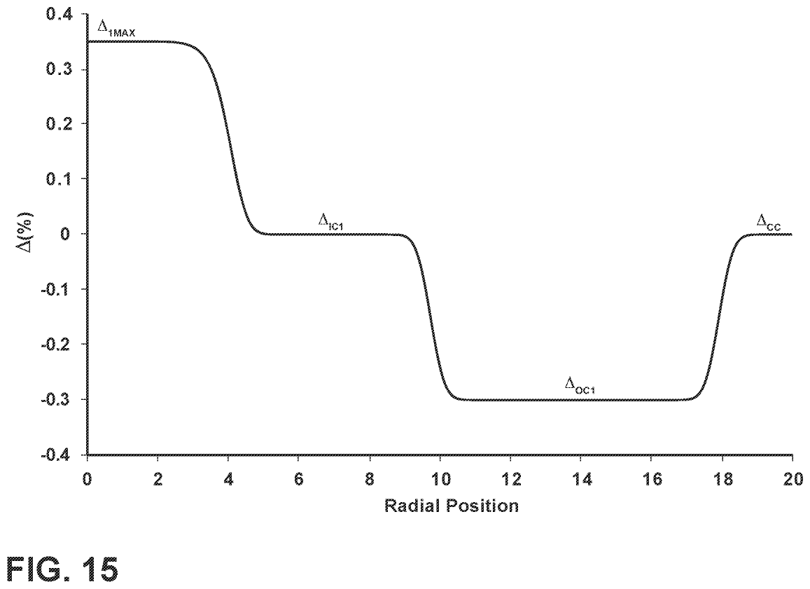

Table 5 below provides the features and optical properties for modeled exemplary multicore optical fibers, Examples 4A-4D (“Ex. 4A,” Ex. 4B,” “Ex. 4C,” and ‘Ex. 4D”). All of the Examples 4A-4D included a chlorine doped core, an undoped silica inner cladding, a fluorine doped outer cladding, and an undoped silica common cladding. Examples 4A-4D can be referred to as having an offset trench. Ex. 4C is illustrated schematically in the refractive index profile of FIG. 15, and includes a graded-index profile.

TABLE 5
Features and Optical Properties of Examples 4A-4D.

| Parameter | Ex. 4A | Ex. 4B | Ex. 4C | Ex. 4D |
|---|---|---|---|---|
| Δ₁, Δ₂ (%) | 0.31 | 0.36 | 0.35 | 0.33 |
| Cl in core (wt%) | 4.95 | 5.74 | 5.63 | 5.20 |
| r₁, r₂ (ina) | 4.54 | 4.70 | 4.34 | 4.43 |
| Core alpha | 14.22 | 5.35 | 11.45 | 12.67 |
| Δ_{IC1}, Δ_{IC2} (%) | 0.00 | 0.00 | 0.00 | 0.00 |
| inner cladding dopant | none | none | none | none |
| r_{IC1}, r_{IC2} (μm) | 10.15 | 10.52 | 9.74 | 10.36 |
| Δr_{IC1}, Δr_{IC2} (μm) | 5.61 | 5.82 | 5.40 | 5.93 |
| Δ_{OC1}, Δ_{OC2} (%) | −0.40 | −0.33 | −0.30 | −0.26 |
| r_{OC1}, r_{OC2} (μm) | 16.01 | 15.92 | 17.92 | 17.11 |
| Δr_{OC1}, Δr_{OC2} (μm) | 5.86 | 5.40 | 8.18 | 6.75 |
| Trench volume (% Δμm²) | 61.1 | 47.7 | 68.9 | 47.6 |
| Outer cladding dopant | F | F | F | F |
| F in outer cladding (wt %) | 1.31 | 1.10 | 1.00 | 0.84 |
| R_{CC} (μm) | 62.5 | 62.5 | 62.5 | 62.5 |
| Δ_{CC} (%) | 0 | 0 | 0 | 0 |
| Common cladding dopant | none | none | none | none |
| Theoretical cutoff wavelength | 1193 | 1209 | 1199 | 1191 |
| (nm) | | | | |
| Cable cutoff wavelength (nm) | 1185 | 1190 | 1195 | 1177 |
| Zero dispersion wavelength | 1301.3 | 1312.2 | 1308.9 | 1308.9 |
| (nm) | | | | |
| Mode field diameter at 1310 nm | 9.38 | 8.93 | 8.85 | 9.18 |
| (μm) | | | | |
| Effective area at 1310 nm (μm²) | 68.89 | 61.67 | 61.09 | 65.60 |
| Dispersion at 1310 nm | 0.79 | −0.20 | 0.10 | 0.10 |
| (ps/nm/km) | | | | |
| Dispersion Slope at 1310 nm | 0.09 | 0.09 | 0.09 | 0.09 |
| (ps/nm²/km) | | | | |
| Mode field diameter at 1550 nm | 10.51 | 10.11 | 9.97 | 10.38 |
| (μm) | | | | |
| Effective area at 1550 nm (μm²) | 84.82 | 77.46 | 75.89 | 82.04 |
| Dispersion at 1550 nm | 18.86 | 17.59 | 17.91 | 17.83 |
| (ps/nm/km) | | | | |
| Dispersion Slope at 1550 nm | 0.06 | 0.06 | 0.06 | 0.06 |
| (ps/nm²/km) | | | | |

The following non-limiting aspects are encompassed by the present disclosure. To the extent not already described, any one of the features of the first through the twenty-sixth aspect may be combined in part or in whole with features of any one or more of the other aspects of the present disclosure to form additional aspects, even if such a combination is not explicitly described.

According to a first aspect of the present disclosure, a multicore optical fiber, includes: a first core comprising silica and greater than 3 wt % chlorine, wherein the first core comprises a first core centerline, a relative refractive index Δ_{1MAX}, and an outer radius r₁; a first inner cladding surrounding the first core and comprising a relative refractive index Δ_{IC1} and a width δr_{IC1}, wherein Δ_{1MAX}>Δ_{IC1}; a second core comprising silica and greater than 3 wt % chlorine, wherein the second core comprises a second core centerline, a relative refractive index Δ_{2MAX}, and an outer radius r₂; a second inner cladding surrounding the second core and comprising a relative refractive index Δ_{IC2} and a width δr_{IC2}, wherein Δ_{2MAX}>Δ_{IC2}, and a common cladding surrounding the first core and the second core and in direct contact with the first inner cladding and the second inner cladding, wherein the common cladding comprises a relative refractive index Δ_{CC}, and wherein a spacing between the first core centerline and the second core centerline is at least 28 micrometers and a crosstalk between the first core and the second core is ≤−30 dB, as measured for a 100 km length of the multicore optical fiber operating at a wavelength of 1550 nm.

According to a second aspect of the present disclosure, the multicore optical fiber according to the first aspect, wherein the first inner cladding and the second inner cladding include one of undoped silica and silica doped with fluorine.

According to a third aspect of the present disclosure, the multicore optical fiber of the first or the second aspect, wherein the common cladding comprises one of undoped silica, silica doped with fluorine, and silica doped with chlorine.

According to a fourth aspect of the present disclosure, the multicore optical fiber of the first aspect, wherein the first inner cladding and the second inner cladding comprise undoped silica and the common cladding comprises silica doped with chlorine.

According to a fifth aspect of the present disclosure, the multicore optical fiber of the first aspect, wherein first inner cladding and the second inner cladding comprise silica doped with fluorine and the common cladding comprises one of undoped silica, silica doped with fluorine, and silica doped with chlorine.

According to a sixth aspect of the present disclosure, the multicore optical fiber of the fifth aspect, wherein the first inner cladding and the second inner cladding comprise silica doped with from about 0.1 wt % to about 0.5 wt % fluorine.

According to a seventh aspect of the present disclosure, the multicore optical fiber of any one of the first aspect to the sixth aspect, wherein: Δ_{1MAX}≥0, Δ_{IC1}≤0, Δ_{CC}≥0, and Δ_{CC}>ΔIC1; and Δ_{2MAX}>0, Δ_{IC2}≤0, Δ_{CC}≥0, and Δ_{CC}>Δ_{IC2}.

According to an eighth aspect of the present disclosure, the multicore optical fiber of any one of the first aspect to the seventh aspect, wherein the first inner cladding and the second inner cladding comprise a trench volume of from about 30% Δ-square micrometers to about 120% Δ-square micrometers.

According to a ninth aspect of the present disclosure, the multicore optical fiber of any one of the first aspect to the seventh aspect, further including: a first outer cladding surrounding the first inner cladding between the first inner cladding and the common cladding, wherein the first outer cladding includes a relative refractive index Δ_{OC1} and a width δr_{OC1}; and a second outer cladding surrounding the second inner cladding between the second inner cladding and the common cladding, wherein the second outer cladding includes a relative refractive index Δ_{OC2} and a width δr_{OC2}.

According to a tenth aspect of the present disclosure, the multicore optical fiber of the ninth aspect, wherein the first inner cladding and the second inner cladding include undoped silica and the first outer cladding and the second outer cladding comprise silica doped with fluorine.

According to an eleventh aspect of the present disclosure, the multicore optical fiber of the tenth aspect, wherein the common cladding includes undoped silica.

According to a twelfth aspect of the present disclosure, the multicore optical fiber of the ninth aspect, wherein: Δ_{1MAX}>0, Δ_{1MAX}>Δ_{IC1}>Δ_{OC1}, and Δ_{CC}>Δ_{OC1}; and Δ_{2MAX}>0, Δ_{2MAX}>Δ_{IC2}>Δ_{OC2}, and Δ_{CC}>Δ_{OC2}.

According to a thirteenth aspect of the present disclosure, the multicore optical fiber of the ninth aspect, wherein the first outer cladding and the second outer cladding comprise a trench volume of from about 30% Δ-square micrometers to about 75% Δ-square micrometers.

According to a fourteenth aspect of the present disclosure, the multicore optical fiber of any one of the first aspect to the thirteenth aspect, wherein first core and the second core comprise greater than 3 wt % and less than 6 wt % chlorine.

According to a fifteenth aspect of the present disclosure, the multicore optical fiber of any one of the first aspect to the fourteenth aspect, wherein the first core outer radius r₁ and the second core outer radius r₂ are from about 2.5 micrometers to about 12.5 micrometers.

According to a sixteenth aspect of the present disclosure, the multicore optical fiber of any one of the first aspect to the fifteenth aspect, wherein the first core and the second core are free of fluorine.

According to a seventeenth aspect of the present disclosure, the multicore optical fiber of any one of the first aspect to the sixteenth aspect, wherein the first core and the second core comprise one of a step index core profile and a graded index core profile.

According to an eighteenth aspect of the present disclosure, the multicore optical fiber of any one of the first aspect to the seventeenth aspect, wherein an attenuation of the first core and the second core is less than 0.175 dB/km at 1550 nm.

According to a nineteenth aspect of the present disclosure, the multicore optical fiber of any one of first aspect to the eighteenth aspect, wherein the multicore optical fiber comprises one of: a circular cross-sectional shape having an outer radius of from about 50 micrometers to about 110 micrometers; and a ribbon cross-sectional shape having a width of from about 50 micrometers to about 400 micrometers.

According to a twentieth aspect of the present disclosure, the multicore optical fiber of any one of the first aspect to the nineteenth aspect, further comprising: i additional cores comprising silica and greater than 3 wt % chlorine, wherein i is 1 to 18, and wherein each additional core comprises a core centerline, a relative refractive index Δ_{MAX}, and an outer radius rᵢ; and an inner core surrounding each additional core and comprising a relative refractive index Δ_{ICi} and a width δr_{ICi}, wherein Δ_{iMAX}>Δ_{ICi}, wherein a spacing between the core centerline of adjacent cores is at least 28 micrometers and a crosstalk between adjacent cores is ≤−30 dB, as measured for a 100 km length of the multicore optical fiber operating at a wavelength of 1550 nm.

According to a twenty-first aspect of the present disclosure, the multicore optical fiber of any one of the first aspect to the twentieth aspect, wherein the crosstalk between the first core and the second core is ≤−40 dB, as measured for a 100 km length of the multicore optical fiber operating at a wavelength of 1550 nm.

According to an twenty-second aspect of the present disclosure, the multicore optical fiber of any one of the first aspect to the twentieth aspect, wherein the crosstalk is ≤−50 dB, as measured for a 100 km length of the multicore optical fiber operating at a wavelength of 1550 nm.

According to a twenty-third aspect of the present disclosure, the multicore optical fiber of any one of the first aspect to the twentieth aspect, wherein the crosstalk is ≤−60 dB, as measured for a 100 km length of the multicore optical fiber operating at a wavelength of 1550 nm.

According to a twenty-fourth aspect of the present disclosure, a multicore optical fiber, includes: a first core comprising silica and greater than 3 wt % chlorine, wherein the first core comprises a first core centerline, a relative refractive index Δ_{1MAX}, and an outer radius r₁; a second core comprising silica and greater than 3 wt % chlorine, wherein the second core comprises a second core centerline, a relative refractive index Δ_{2MAX}, and an outer radius r₂; and a common cladding formed from silica-based glass surrounding and in direct contact with the first core and the second core, the common cladding having a relative refractive index Δcc, wherein a spacing between the first core centerline and the second core centerline is at least 28 micrometers and a crosstalk between the first core and the second core is ≤−30 dB, as measured for a 100 km length of the multicore optical fiber operating at a wavelength of 1550 nm.

According to a twenty-fifth aspect of the present disclosure, the multicore optical fiber of the twenty-fourth aspect, wherein the common cladding comprises undoped silica.

According to a twenty-sixth aspect of the present disclosure, the multicore optical fiber of the twenty-fourth aspect or the twenty-fifth aspect, wherein the first core and the second core comprise greater than 3 wt % and less than 6 wt % chlorine.

According to a twenty-seventh aspect of the present disclosure, the multicore optical fiber of any one of the twenty-fourth aspect to the twenty-sixth aspect, wherein the first core outer radius r₁ and the second core outer radius r₂ are from about 2.5 micrometers to about 12.5 micrometers.

According to a twenty-eighth aspect of the present disclosure, the multicore optical fiber of any one of the twenty-fourth aspect to the twenty-seventh aspect, wherein the first core and the second core are substantially free of fluorine.

According to a twenty-ninth aspect of the present disclosure, the multicore optical fiber of any one of the twenty-fourth aspect to the twenty-eighth aspect, wherein the first core and the second core comprise one of a step index core profile and a graded index core profile.

According to a thirtieth aspect of the present disclosure, the multicore optical fiber of any one of the twenty-fourth aspect to the twenty-ninth aspect, wherein an attenuation of the first core and the second core is less than 0.175 dB/km at 1550 nm.

According to a thirty-first aspect of the present disclosure, the multicore optical fiber of any one of the twenty-fourth aspect to the thirtieth aspect, wherein the multicore optical fiber comprises one of: a circular cross-sectional shape having an outer radius of from about 50 micrometers to about 110 micrometers; and a ribbon cross-sectional shape having a width of from about 50 micrometers to about 400 micrometers.

According to a thirty-second aspect of the present disclosure, the multicore optical fiber of any one of the twenty-fourth aspect to the thirty-first aspect, further comprising: i additional cores comprising silica and greater than 3 wt % chlorine, wherein i is 1 to 18, and wherein each additional core comprises a core centerline, a relative refractive index Δ_{iMAX}, and an outer radius rᵢ, and wherein a spacing between the core centerline of adjacent cores is at least 28 micrometers and a crosstalk between adjacent cores is ≤−30 dB, as measured for a 100 km length of the multicore optical fiber operating at a wavelength of 1550 nm.

According to a thirty-third aspect of the present disclosure, the multicore optical fiber of any one of the twenty-fourth aspect to the thirty-second aspect, wherein the crosstalk between the first core and the second core is ≤−40 dB, as measured for a 100 km length of the multicore optical fiber operating at a wavelength of 1550 nm.

According to a thirty-fourth aspect of the present disclosure, the multicore optical fiber of any one of the twenty-fourth aspect to the thirty-second aspect, wherein the crosstalk is ≤−50 dB, as measured for a 100 km length of the multicore optical fiber operating at a wavelength of 1550 nm.

According to a thirty-fifth aspect of the present disclosure, the multicore optical fiber of any one of the twenty-fourth aspect to the thirty-second aspect, wherein the crosstalk is ≤−60 dB, as measured for a 100 km length of the multicore optical fiber operating at a wavelength of 1550 nm.

Many variations and modifications may be made to the above-described embodiments of the disclosure without departing substantially from the spirit and various principles of the disclosure. All such modifications and variations are intended to be included herein within the scope of this disclosure and protected by the following claims. It will be understood that any described processes or steps within described processes may be combined with other disclosed processes or steps to form structures within the scope of the present disclosure. The exemplary structures and processes disclosed herein are for illustrative purposes and are not to be construed as limiting.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

What is claimed is:

1. A multicore optical fiber, comprising:
a first core comprising silica and greater than 3 wt % chlorine, wherein the first core comprises a first core centerline, a relative refractive index Δ_{1MAX}, and an outer radius r₁;
a first inner cladding surrounding the first core and comprising a relative refractive index Δ_{IC1} and a width δr_{IC1}, wherein Δ_{1MAX}>Δ_{IC1};
a second core comprising silica and greater than 3 wt % chlorine, wherein the second core comprises a second core centerline, a relative refractive index Δ_{2MAX}, and an outer radius r₂;
a second inner cladding surrounding the second core and comprising a relative refractive index Δ_{IC2} and a width δr_{IC2}, wherein Δ_{2MAX}>Δ_{IC2}; and
a common cladding surrounding the first core and the second core, wherein the common cladding comprises a relative refractive index Δ_{CC}, and
wherein a spacing between the first core centerline and the second core centerline is at least 28 micrometers and a crosstalk between the first core and the second core is ≤−30 dB, as measured for a 100 km length of the multicore optical fiber operating at a wavelength of 1550 nm.

2. The multicore optical fiber of claim 1, wherein the first inner cladding and the second inner cladding comprise one of undoped silica and silica doped with fluorine.

3. The multicore optical fiber of claim 1, wherein the common cladding comprises one of undoped silica, silica doped with fluorine, and silica doped with chlorine.

4. The multicore optical fiber of claim 1, wherein the first inner cladding and the second inner cladding comprise undoped silica and the common cladding comprises silica doped with chlorine.

5. The multicore optical fiber of claim 1, wherein first inner cladding and the second inner cladding comprise silica doped with fluorine and the common cladding comprises one of undoped silica, silica doped with fluorine, and silica doped with chlorine.

6. The multicore optical fiber of claim 5, wherein the first inner cladding and the second inner cladding comprise silica doped with from about 0.1 wt % to about 0.5 wt % fluorine.

7. The multicore optical fiber of claim 1, wherein:
Δ_{1MAX}>0,Δ_{IC1}≤0,Δ_{CC}≥0, and Δ_{CC}>Δ_{IC1}; and
Δ_{2MAX}>0,Δ_{IC2}≤0,Δ_{CC}≥0, and Δ_{CC}>Δ_{IC2}.

8. The multicore optical fiber of claim 1, further comprising:
a first outer cladding surrounding the first inner cladding between the first inner cladding and the common cladding, wherein the first outer cladding includes a relative refractive index Δ_{OC1} and a width δr_{OC1}; and
a second outer cladding surrounding the second inner cladding between the second inner cladding and the common cladding, wherein the second outer cladding includes a relative refractive index Δ_{OC2} and a width δr_{OC2}.

9. The multicore optical fiber of claim 8, wherein the first inner cladding and the second inner cladding comprise undoped silica and the first outer cladding and the second outer cladding comprise silica doped with fluorine.

10. The multicore optical fiber of claim 9, wherein the common cladding comprises undoped silica.

11. The multicore optical fiber of claim 8, wherein:
Δ_{1MAX}>0,Δ_{1MAX}>Δ_{IC1}>Δ_{OC1}, and Δ_{CC}>Δ_{OC1}; and
Δ_{2MAX}>0,Δ_{2MAX}>Δ_{IC2}>Δ_{OC2}, and Δ_{CC}>Δ_{OC2}.

12. The multicore optical fiber of claim 1, wherein the first core and the second core comprise greater than 3 wt % and less than 6 wt % chlorine.

13. The multicore optical fiber of claim 1, wherein the first core and the second core are free of fluorine.

14. The multicore optical fiber of claim 1, wherein an attenuation of the first core and the second core is less than 0.175 dB/km at 1550 nm.

15. The multicore optical fiber of claim 1, further comprising:
i additional cores comprising silica and greater than 3 wt % chlorine, wherein i is 1 to 18, and wherein each additional core comprises a core centerline, a relative refractive index Δ_{MAX}, and an outer radius rᵢ; and
an inner cladding surrounding each additional core and comprising a relative refractive index Δ_{ICi} and a width δr_{ICi}, wherein Δ_{iMAX}>Δ_{ICi},
wherein a spacing between the core centerline of adjacent cores is at least 28 micrometers and a crosstalk between adjacent cores is ≤−30 dB, as measured for a 100 km length of the multicore optical fiber operating at a wavelength of 1550 nm.

16. A multicore optical fiber, comprising:
a first core comprising silica and greater than 3 wt % chlorine, wherein the first core comprises a first core centerline, a relative refractive index Δ_{1MAX}, and an outer radius r₁;
a second core comprising silica and greater than 3 wt % chlorine, wherein the second core comprises a second core centerline, a relative refractive index Δ_{2MAX}, and an outer radius r₂; and
a common cladding formed from silica-based glass surrounding and in direct contact with the first core and the second core, the common cladding having a relative refractive index Δ_{CC},
wherein a spacing between the first core centerline and the second core centerline is at least 28 micrometers and a crosstalk between the first core and the second core is ≤−30 dB, as measured for a 100 km length of the multicore optical fiber operating at a wavelength of 1550 nm.

17. The multicore optical fiber of claim 16, wherein the common cladding comprises undoped silica.

18. The multicore optical fiber of claim 16, wherein the first core and the second core are substantially free of fluorine.

19. The multicore optical fiber of claim 16, wherein an attenuation of the first core and the second core is less than 0.175 dB/km at 1550 nm.

20. The multicore optical fiber of claim 16, further comprising:
i additional cores comprising silica and greater than 3 wt % chlorine, wherein i is 1 to 18, and wherein each additional core comprises a core centerline, a relative refractive index Δ_{iMAX}, and an outer radius rᵢ, and
wherein a spacing between the core centerline of adjacent cores is at least 28 micrometers and a crosstalk between adjacent cores is ≤−30 dB, as measured for a 100 km length of the multicore optical fiber operating at a wavelength of 1550 nm.
